(19) United States
(12) Patent Application Publication
(10) Pub. No.: US 2026/0169342 A1
(43) Pub. Date: Jun. 18, 2026

(54) DISPLAY PANEL, DISPLAY APPARATUS, AND MANUFACTURING METHOD FOR DISPLAY PANEL

(71) Applicant: Shanghai Tiamna Microelectronics co., Ltd., Shanghai (CN)

(72) Inventors: Jian JIN, Shanghai (CN); Yuan DING, Shanghai (CN)

(73) Assignee: Shanghai Tiamna Microelectronics co., Ltd., Shanghai (CN)

(21) Appl. No.: 19/212,629

(22) Filed: May 19, 2025

(30) Foreign Application Priority Data
Dec. 17, 2024 (CN) 202411872352.6

(51) Int. Cl. G02F 1/1677; G02F 1/167; G02F 1/1676

(52) U.S. Cl. CPC G02F 1/1677; G02F 1/167; G02F 1/1676

(57) ABSTRACT

The present application provides a display panel, a display apparatus, and a manufacturing method for a display panel. The display panel comprises a first substrate, a colored ink layer, a plurality of pixel electrodes, and an electrophoresis layer. The colored ink layer is disposed on one side of the first substrate, and comprises a plurality of ink portions comprising first ink portions and second ink portions having different colors. The plurality of pixel electrodes are disposed on one side of the first substrate, and the pixel electrodes comprise first electrodes corresponding to the first ink portions and second electrodes corresponding to the second ink portions. The electrophoresis layer is disposed on the side of the colored ink layer and the pixel electrodes away from the first substrate, the electrophoresis layer comprise electrophoretic particles.

### CROSS REFERENCE TO RELATED APPLICATION

The present application claims priority to Chinese Patent Application No. 202411872352.6 filed on Dec. 17, 2024, which is incorporated herein by reference in its entirety.

### TECHNICAL FIELD

The present application relates to the technical field of display devices, in particular to a display panel, a display apparatus, and a manufacturing method for a display panel.

### BACKGROUND

With the development of science and technology, display apparatuses have also developed, and the types of display apparatuses are increasingly diverse. Existing display apparatuses include liquid crystal display apparatuses, organic electroluminescent display apparatuses, electrophoretic display apparatuses, and the like. Among them, the electrophoretic display apparatuses have become a type of increasingly important display apparatuses due to their advantages of low energy consumption, high reflectivity, and high contrast.

### SUMMARY

In a first aspect, embodiments of the present application provide a display panel including a first substrate, a colored ink layer, a plurality of pixel electrodes, and an electrophoresis layer. The colored ink layer is disposed on one side of the first substrate, the colored ink layer includes a plurality of ink portions, the plurality of ink portions include first ink portions and second ink portion, and the color of the first ink portions is different from the color of the second ink portions. The plurality of pixel electrodes are disposed at one side of the first substrate, and the pixel electrodes include first electrodes corresponding to the first ink portions and second electrodes corresponding to the second ink portions.

The electrophoresis layer is disposed on the side of the colored ink layer and the pixel electrodes away from the first substrate, the electrophoresis layer includes electrophoretic particles, the orthographic projection of the first ink portion on the first substrate is at least partially located between the orthographic projections of two of the first electrodes on the first substrate, and the orthographic projection of the second ink portion on the first substrate is at least partially located between the orthographic projections of two of the second electrodes on the first substrate.

In a second aspect, embodiments of the present application provide a display apparatus including a first substrate, a colored ink layer, a plurality of pixel electrodes, and an electrophoresis layer. The colored ink layer is disposed on one side of the first substrate, the colored ink layer includes a plurality of ink portions, the plurality of ink portions include first ink portions and second ink portion, and the color of the first ink portions is different from the color of the second ink portions. The plurality of pixel electrodes are disposed at one side of the first substrate, and the pixel electrodes include first electrodes corresponding to the first ink portions and second electrodes corresponding to the second ink portions.

### BRIEF DESCRIPTION OF THE DRAWINGS

In order to explain the technical solutions of the embodiments of the present application more clearly, the accompanying drawings required for use in the embodiments of the present application will be briefly introduced below. Those of ordinary skill in the art can derive other drawings based on the accompanying drawings without any creative effort.

FIG. 1 is a cross-sectional structural view of a display panel provided in an embodiment of the present application in a first color state;

FIG. 2 is a cross-sectional structural view of the display panel provided in an embodiment of the present application in a second color state;

FIG. 3 is a cross-sectional structural view of the display panel provided in an embodiment of the present application in another color state;

FIG. 4 is a cross-sectional structural view of the display panel provided in an embodiment of the present application in a black state;

FIG. 5 is a schematic structural view of relative positions of ink portions and pixel electrodes in the display panel provided in an embodiment of the present application;

FIG. 6 is another schematic view of a positional relationship between ink portions and pixel electrodes in the display panel provided in an embodiment of the present application;

FIG. 7 is another cross-sectional structural view of the display panel provided in an embodiment of the present application;

FIG. 8 is another cross-sectional structural view of the display panel provided in an embodiment of the present application;

FIG. 9 is another schematic view of positional relationships between support columns, pixel electrodes, and ink portions in the display panel provided in an embodiment of the present application;

FIG. 10 is another cross-sectional structural view of the display panel provided in an embodiment of the present application;

FIG. 11 is another cross-sectional structural view of the display panel provided in an embodiment of the present application;

FIG. 12 is another cross-sectional structural view of the display panel provided in an embodiment of the present application;

FIG. 13 is another cross-sectional structural view of the display panel provided in an embodiment of the present application;

FIG. 14 is another cross-sectional structural view of the display panel provided in an embodiment of the present application;

FIG. 15 is another schematic view of a positional relationship between pixel electrodes and ink portions in the display panel provided in an embodiment of the present application;

FIG. 16 is another cross-sectional structural view of the display panel provided in an embodiment of the present application;

FIG. 17 is an enlarged structural view of region Q in FIG. 16;

FIG. 18 is an enlarged structural view of region V in FIG. 16;

FIG. 19 is another cross-sectional structural view of the display panel provided in an embodiment of the present application;

FIG. 20 is another cross-sectional structural view of the display panel provided in an embodiment of the present application;

FIG. 21 is an enlarged structural view of region P in FIG. 20;

FIG. 22 is another cross-sectional structural view of the display panel provided in an embodiment of the present application;

FIG. 23 is an enlarged structural view of region N in FIG. 22;

FIG. 24 is another cross-sectional structural view of the display panel provided in an embodiment of the present application;

FIG. 25 is another partial cross-sectional structural view of the display panel provided in an embodiment of the present application;

FIG. 26 is another cross-sectional structural view of the display panel provided in an embodiment of the present application;

FIG. 27 is a schematic structural view of a display apparatus provided in an embodiment of the present application;

FIG. 28 is a flowchart of a manufacturing method for a display panel provided in an embodiment of the present application; and

FIG. 29A to FIG. 29E are process structure views of the manufacturing method for the display panel provided in an embodiment of the present application.

### LIST OF REFERENCES

100. Display panel; 200. Display apparatus;
10. First substrate;
20. Colored ink layer; 21. Ink portion; 211. Second protrusion; 212. First arc surface; 213. Second body portion; 214. Tangent plane; 22. First ink portion; 23. Second ink portion; 24. First-type ink portion; 25. Second-type ink portion; 26. Connection portion; 27. Third ink portion;
30. Pixel electrode; 31. First electrode; 32. Second electrode; 33. First-type electrode; 34. Second-type electrode; 35. First protrusion; 351. First side wall; 352. First bottom wall; 36. First body portion;
40. Electrophoresis layer; 41. Electrophoretic particle;
50. Common electrode; 51. Electrode portion; 52. First surface; 53. Second arc surface;
60. Support column; 61. Support layer;
70. Connection function layer; 71. Open structure;
C. Repeat unit; T1. First orthographic projection; T2. Second orthographic projection; E1. First edge; E2. Second edge; M1. First top surface; M2. Second top surface;
X. First direction; Y. Second direction; Z. Thickness direction.

### DETAILED DESCRIPTION

Features and exemplary embodiments of various aspects of the present application will be described in detail below. In order to make the objectives, technical solutions, and advantages of the present application clearer, the present application will be further described in detail below with reference to the accompanying drawings and specific embodiments. It should be understood that the specific embodiments described here are only intended to explain the present application, but not to limit the present application. For those skilled in the art, the present application can be implemented without some of these specific details. The following descriptions of the embodiments are merely for providing a better understanding of the present invention by showing examples of the present invention.

It should be noted that the relational terms herein, such as first and second, are merely used for distinguishing one entity or operation from another, and do not necessarily require or imply that any actual relationship or sequence exists between these entities or operations. Moreover, the terms “include”, “comprise”, and any variants thereof are intended to cover a non-exclusive inclusion, such that a process, method, article, or device including a series of elements not only includes those elements, but further includes other elements not listed explicitly, or includes inherent elements of the process, method, article, or device. In the absence of more limitations, an element defined by “include a . . . ” does not exclude other same elements existing in the process, method, article, or device including the element.

An electrophoretic display panel presents different color display effects by means of electrophoretic particles with specific colors and electrical properties when moving in a liquid environment under an external electric field. In related technologies, the electrophoretic display panel can achieve the color display effects by cooperation of black and white electrophoretic particles and a color film layer, or by mutual cooperation of electrophoretic particles with different colors.

The inventor found by research that, for a scheme of a color film layer, the color film layer is located above the black and white electrophoretic particles, and ambient light first passes through the color film layer to reach the positions of the electrophoretic particles, then is totally reflected at the white electrophoretic particles, and finally exits from the color film layer to the user's eyes, thereby achieving the display effect. In this design, the ambient light needs to pass through the color film layer twice, and due to the low transmittance of the color film layer, the display effect of the electrophoretic display panel is poor.

For a scheme of electrophoretic particles with different colors, the multi-color electrophoretic particles are driven in complex ways when displaying color images, and the electrophoretic particles with different colors are prone to mutual interference, resulting in low response speed and long response time of the electrophoretic display panel, which can easily lead to poor display effects.

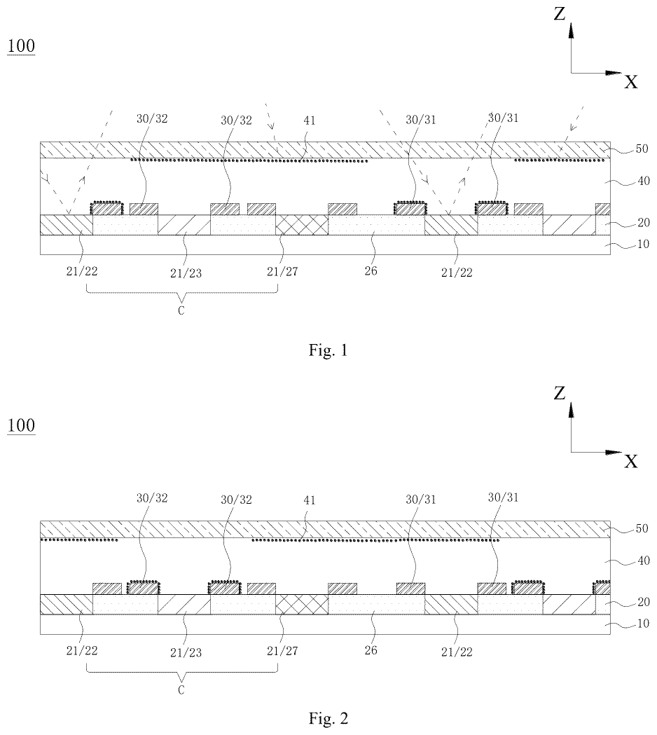

In view of the above problems, in a first aspect, with reference to FIG. 1, an embodiment of the present application provides a display panel 100. The display panel 100 includes a first substrate 10, a colored ink layer 20, a plurality of pixel electrodes 30, and an electrophoresis layer 40. The colored ink layer 20 is disposed on one side of the first substrate 10, the colored ink layer 20 includes a plurality of ink portions 21, and the plurality of ink portions 21 include first ink portions 22 and second ink portions 23 of different colors. The plurality of pixel electrodes 30 are disposed on one side of the first substrate 10, and the pixel electrodes 30 include first electrodes 31 corresponding to the first ink portions 22 and second electrodes 32 corresponding to the second ink portions 23.

The electrophoresis layer 40 is disposed on the side of the colored ink layer 20 and the pixel electrodes 30 away from the first substrate 10, the electrophoresis layer 40 includes electrophoretic particles 41, the orthographic projection of the first ink portion 22 on the first substrate 10 is at least partially located between the orthographic projections of two of the first electrodes 31 on the first substrate 10, and the orthographic projection of the second ink portion 23 on the first substrate 10 is at least partially located between the orthographic projections of two of the second electrodes 32 on the first substrate 10.

The first substrate 10 may serve as a carrier for carrying some film layer structures in the display panel 100. The first substrate 10 may include a glass substrate, that is, the display panel 100 has a rigid structure. Alternatively, the first substrate 10 may include a flexible substrate, that is, the display panel 100 may have a flexible structure to meet the folding requirement of the display panel 100. The embodiments of the present application do not limit this.

The electrophoresis layer 40 is disposed on one side of the first substrate 10, and the electrophoresis layer 40 includes a plurality of electrophoretic particles 41. In related technologies, the electrophoretic display panel 100 includes electrophoretic particles of at least two colors. By changing the positional relationship between the electrophoretic particles 41 of different colors, images of the display panel 100 can be switched. However, in the embodiments of the present application, the electrophoretic particles 41 are not components used for achieving display effects, but only serve to block light. In other words, the display panel 100 includes electrophoretic particles 41 of only one charge polarity, and the electrophoretic particles 41 include a black shading material.

It should be noted that the charge polarity mentioned here refers to electro-positivity or electro-negativity of charges carried by the electrophoretic particles 41. The electrophoretic particles 41 may be all positive particles or all negative particles. For different electrophoretic particles 41, although the electrophoretic particles 41 each correspondingly include a black shading material and have the same charge polarity, different electrophoretic particles 41 may have the same shape and size or different shapes and sizes, and different electrophoretic particles 41 may have the same or different quantity of electrical charges, which is not limited by the embodiments of the present application.

The colored ink layer 20 and the electrophoresis layer 40 are disposed on the same side of the first substrate 10. The colored ink layer 20 is a main component to achieve color display of the display panel 100. The colored ink layer 20 includes a plurality of ink portions 21, the ink portion 21 includes an ink material, and ambient light propagating to the ink portions 21 can be reflected by the ink portions 21 and exits the display panel 100. In FIG. 1, the propagation process of ambient light in the display panel 100 is illustrated by dashed lines.

Due to different colors of different ink portions 21, the ambient light can be reflected by different ink portions 21 and turned into light of different colors. For example, if the colored ink layer 20 includes green ink portions 21, the ambient light propagating to the green ink portion 21 can be reflected and turned into green light, and exits the display panel 100. If the colored ink layer 20 includes red ink portions 21, the ambient light propagating to the red ink portion 21 can be reflected and turned into red light, and exits the display panel 100.

The plurality of ink portions 21 include first ink portions 22 and second ink portions 23 of different colors. The embodiments of the present application do not limit the color types of the first ink portion 22 and the second ink portion 23, as long as both the first ink portion 22 and the second ink portion 23 are colored and have different colors. Optionally, the first ink portion 22 and the second ink portion 23 each include one of a red ink portion 21, a green ink portion 21, and a blue ink portion 21.

According to different actual needs, the plurality of ink portions 21 may include only the first ink portion 22 and the second ink portion 23 as ink portions 21 of two colors, or further include ink portions 21 of other colors. The embodiments of the present application do not limit this.

In addition to the aforementioned film layer structures, the display panel 100 further includes a plurality of pixel electrodes 30. The pixel electrodes 30 are device structures for controlling the positions of the electrophoretic particles 41. The pixel electrodes 30 include first electrodes 31 corresponding to the first ink portions 22 and second electrode 32 corresponding to the second ink portions 23. The expression “first electrodes 31 corresponding to the first ink portions 22″ means that the first electrode 31 can control some electrophoretic particles 41 corresponding to the position of the first ink portion 22. In other words, the electrophoresis layer 40 has a first region overlapping the orthographic projection of the first ink portion 22 on the first substrate 10, and the first electrode 31 can control the distribution state of the electrophoretic particles 41 located in the first region. The similar explanation holds true for the expression ”second electrodes 32 corresponding to the second ink portions 23″, and will not be repeated in the embodiments of the present application.

A single first ink portion 22 may be provided correspondingly with a plurality of first electrodes 31, and the plurality of first electrodes 31 are correspondingly located at different positions on the periphery of the first ink portion 22. Depending on different actual needs, the orthographic projection of the first electrode 31 on the first substrate 10 may overlap with the orthographic projection of the first ink portion 22 on the first substrate 10, or the orthographic projection of the first electrode 31 on the first substrate 10 may be completely located outside the orthographic projection of the first ink portion 22 on the first substrate 10, as long as the orthographic projection of the first ink portion 22 on the first substrate 10 is at least partially located between the orthographic projections of two of the first electrodes 31 on the first substrate 10. “Two of the first electrodes 31” mentioned here refer to two first electrodes 31 adjacent in a single direction. The orthographic projections of the first ink portion 22 and the two first electrodes 31 on the first substrate 10 may or may not overlap.

A single first ink portion 22 may be correspondingly provided with only two first electrodes 31 or more first electrodes 31, and the plurality of first electrodes 31 corresponding to the single first ink portion 22 can be jointly driven and controlled by the same signal. On this basis, different first electrodes 31 corresponding to the single first ink portion 22 can be connected with each other, such that only one signal trace connected to the first electrodes 31 is needed to meet the requirement for driving the plurality of first electrodes 31 corresponding to the single first ink portion 22. Alternatively, in other embodiments, all the first electrodes 31 corresponding to the single first ink portion 22 can be spaced apart from each other, such that a plurality of signal traces are connected to different first electrodes 31 respectively, and the signal traces can be used for transmitting the same signal voltage.

In addition, the first electrode 31 may have various sizes and shapes, for example, its orthographic projection on the first substrate 10 may include a straight line structure or an arc-shaped structure. Optionally, the size and shape of the first electrode 31 correspond to those of the first ink portion 22. For example, if the orthographic projection of the first ink portion 22 on the first substrate 10 has a polygonal structure such as a triangle or square, the first electrode 31 may include a straight line structure and corresponds to one edge of the polygon; if the orthographic projection of the first ink portion 22 on the first substrate 10 is circular, the first electrode 31 may include an arc-shaped structure.

The relationship between the second ink portion 23 and the second electrode 32 is similar to the relationship between the first ink portion 22 and the first electrode 31, and will not be repeated in this embodiment of the present application. However, for the first electrode 31 and the second electrode 32, in order to meet the driving requirements of multi-color display, the first electrode 31 and the second electrode 32 need to be insulated from each other. In other words, at the same time, the first electrode 31 and the second electrode 32 may have the same voltage value or different voltage values. In this design, the first electrode 31, while not affected by the internal signal voltage of the second electrode 32, can freely control the distribution state of the electrophoretic particles 41 above the first ink portion 22. Similarly, the second electrode 32, while not affected by the internal signal voltage of the first electrode 31, can freely control the distribution state of the electrophoretic particles 41 above the second ink portion 23, so as to meet independent display driving requirements of different color images.

In the embodiments of the present application, the electrophoresis layer 40 includes only one type of electrophoretic particles 41, and this type of electrophoretic particles 41 can block ambient light. The first electrode 31 and the second electrode 32 respectively correspond to the first ink portion 22 and the second ink portion 23, and independently control the distribution of the electrophoretic particles 41 at the corresponding positions of the first ink portion 22 and the second ink portion 23. On this basis, the display panel 100 can selectively control through the first electrode 31 whether the electrophoretic particles 41 cover the region where the first ink portion 22 is located, thereby adjusting the amount of ambient light propagating to the first ink portion 22 and achieving display control on the specific color corresponding to the first ink portion 22. And the display panel can selectively control through the second electrode 32 whether the electrophoretic particles 41 cover the region where the second ink portion 23 is located, thereby adjusting the amount of ambient light propagating to the second ink portion 23 and achieving display control on the specific color corresponding to the second ink portion 23. In this case, the display panel 100 can achieve the display needs of color images by joint cooperation of the colored ink layer 20, the electrophoresis layer 40, and the pixel electrodes 30.

Moreover, during the display process, ambient light first passes through the electrophoresis layer 40 to reach the colored ink layer 20, and then exits the display panel 100 by the reflection of the colored ink layer 20. In this process, the ambient light undergoes only one reflection process, but does not undergo multiple times of reflection or filtering treatment, thereby improving the brightness and display effect. Meanwhile, because only one type of electrophoretic particles 41 can be provided in the electrophoresis layer 40, the risk of mutual interference between different electrophoretic particles 41 is low, which is conducive to improving the response rate of the display panel 100 and thus also improves the display effect of the display panel 100.

Notably, in addition to the above structure, the display panel 100 further includes other devices and film layer structures. The specific composition of the display panel 100 is not limited by the embodiments of the present application. In some optional embodiments, the display panel 100 further includes a common electrode 50 disposed on the side of the electrophoresis layer 40 away from the first substrate 10, and the orthographic projections of the first electrode 31 and the second electrode 32 on the first substrate 10 are located within the orthographic projection of the common electrode 50 on the first substrate 10.

The common electrode 50 may have a planar structure, and its orthographic projection on the first substrate 10 may cover the orthographic projections of the plurality of pixel electrodes 30 including the first electrode 31 and the second electrode 32 on the first substrate 10. The pixel electrodes 30 and the common electrode 50 are spaced apart in a thickness direction Z of the display panel 100, and can define an electric field structure to control the distribution state of the electrophoretic particles 41. On this basis, because the first electrode 31 corresponds to the first ink portion 22, the electric field structure formed by the first electrode 31 and the common electrode 50 can control the distribution of the electrophoretic particles 41 above the first ink portion 22, and selectively control the electrophoretic particles 41 to cover or not cover the first ink portion 22 according to different situations. Similarly, because the second electrode 32 corresponds to the second ink portion 23, the electric field structure formed by the second electrode 32 and the common electrode 50 can control the distribution of the electrophoretic particles 41 above the second ink portion 23, and selectively control the electrophoretic particles 41 to shield or not shield the second ink portion 23 according to different situations.

In some embodiments, with reference to FIG. 1 and FIG. 2, the electrophoretic particles 41 are positively charged, and the display panel 100 has a first color state and a second color state; in the first color state, the voltage of the common electrode 50 is V1, the voltage of the first electrode 31 is V2, the voltage of the second electrode 32 is V3, and V3>V1>V2; in the second color state, the voltage of the common electrode 50 is V4, the voltage of the first electrode 31 is V5, the voltage of the second electrode 32 is V6, and V5>V4>V6.

The expression “first color state” mentioned here refers to a state when the display panel 100 displays the same color as the first ink portion 22. If the first ink portion 22 includes a green ink portion 21, the first color state is a state when the display panel 100 displays a green image. If the first ink portion 22 includes a red ink portion 21, the first color state is a state when the display panel 100 displays a red image. Similarly, the expression “second color state” mentioned here refers to a state when the display panel 100 displays the same color as the second ink portion 23.

As shown in FIG. 1, in the first color state, in order to meet the display requirements, the electrophoretic particles 41 do not cover the first ink portion 22 but cover the second ink portion 23, such that ambient light can propagate to the first ink portion 22 and be reflected by the first ink portion 22, but cannot propagate to the second ink portion 23 or be reflected by the second ink portion 23. In view of this, the embodiment of the present application sets the voltage V2 of the first electrode 31 in the first color state to be less than the voltage V1 of the common electrode 50, such that in the electric field structure formed by the first electrode 31 and the common electrode 50, the positive electrophoretic particles 41 can be repelled by the common electrode 50, attracted by the first electrode 31 and gathered at the position of the first electrode 31. As such, at least a portion of the first ink portion 22 can be unobstructed by the electrophoretic particles 41, ambient light can propagate to the first ink portion 22 and be reflected by the first ink portion 22 to turn into light of a specific color, and ultimately exits the display panel 100.

The embodiments of the present application further set the voltage V3 of the second electrode 32 in the first color state to be greater than the voltage V1 of the common electrode 50, such that in the electric field structure formed by the second electrode 32 and the common electrode 50, the positive electrophoretic particles 41 can be repelled by the second electrode 32, attracted by the common electrode 50 and gathered at the position of the common electrode 50. As such, the electrophoretic particles 41 gathered at the common electrode 50 can cover and shield most of the region in the second ink portion 23, most of the ambient light cannot propagate to the second ink portion 23, and even if some of the ambient light passes through the electrophoretic particles 41 and propagates to the second ink portion 23, but due to the obstruction of the electrophoretic particles 41, the light reflected off at the second ink portion 23 hardly exits the display panel 100.

It should be noted that the specific values of V1, V2, and V3 are not limited by the embodiments of the present application. V1, V2, and V3 may be positive, negative, or 0, as long as V3>V1>V2 is satisfied. In addition, depending on different actual needs, the electrophoretic particle 41 may be negatively charged. In order to meet the display requirements of the first color state, V1, V2, and V3 need to satisfy: V2>V1>V3.

As shown in FIG. 2, in the second color state, in order to meet the display requirements, the electrophoretic particles 41 cover the first ink portion 22 but do not cover the second ink portion 23, such that ambient light can propagate to the second ink portion 23 and be reflected by the second ink portion 23, but cannot propagate to the first ink portion 22 or be reflected by the first ink portion 22. In view of this, the embodiment of the present application sets the voltage V6 of the second electrode 32 in the second color state to be less than the voltage V4 of the common electrode 50, such that in the electric field structure formed by the second electrode 32 and the common electrode 50, the positive electrophoretic particles 41 can be repelled by the common electrode 50, attracted by the second electrode 32 and gathered at the position of the second electrode 32. As such, at least a portion of the second ink portion 23 can be unobstructed by the electrophoretic particles 41, ambient light can propagate to the second ink portion 23 and be reflected by the second ink portion 23 to turn into light of a specific color, and ultimately exits the display panel 100.

The embodiments of the present application further set the voltage V5 of the first electrode 31 in the second color state to be greater than the voltage V4 of the common electrode 50, such that in the electric field structure formed by the first electrode 31 and the common electrode 50, the positive electrophoretic particles 41 can be repelled by the first electrode 31, attracted by the common electrode 50 and gathered at the position of the common electrode 50. As such, the electrophoretic particles 41 gathered at the common electrode 50 can cover and shield most of the region in the first ink portion 22, most of the ambient light cannot propagate to the first ink portion 22, and even if some of the ambient light passes through the electrophoretic particles 41 and propagates to the first ink portion 22, but due to the obstruction of the electrophoretic particles 41, the light reflected off at the first ink portion 22 hardly exits the display panel 100.

It should be noted that the specific values of V4, V5, and V6 are not limited by the embodiments of the present application. V4, V5, and V6 may be positive, negative, or 0, as long as V5>V4>V6 is satisfied. In addition, depending on different actual needs, the electrophoretic particle 41 may be negatively charged. In order to meet the display requirements of the first color state, V4, V5, and V6 need to satisfy: V6>V4>V5.

In addition, for the voltage V1 of the common electrode 50 in the first color state and the voltage V4 of the common electrode 50 in the second color state, depending on different actual needs, V1 may be equal to V4, or V1 may be greater than or equal to V4. Optionally, V1=V4. In this case, during the transition between the first color state and the second color state, the voltage of the common electrode 50 may not be adjusted, and only the voltages in different pixel electrodes 30 are changed to switch display colors, thereby reducing control difficulty and improving image switching efficiency.

The voltage V2 of the first electrode 31 in the first color state and the voltage V6 of the second electrode 32 in the second color state may be the same or different. Similarly, the voltage V3 of the second electrode 32 in the first color state and the voltage V5 of the first electrode 31 in the second color state may be the same or different, which is not limited by the embodiments of the present application. Optionally, V2=V6 and V3=V5.

Further, optionally, V1=V4=0, V2=V6<0, and V3=V5>0. In both the first color state and the second color state, the common electrode 50 does not have a signal voltage, which is conducive to reducing the display power consumption of the display panel 100. For example, V2=V6=−15 V and V3=V5=15 V.

In the embodiments of the present application, for two different display states of the first color state and the second color state, the voltage of the first electrode 31 and the voltage of the second electrode 32 remain different in both states, and the voltage values of the first electrode 31 and the common electrode 50 are also different, such that the first ink portion 22 in the first color state will not be covered by the electrophoretic particles 41, while the first ink portion 22 in the second color state will be covered by the electrophoretic particles 41. The voltage values of the second electrode 32 and the common electrode 50 may also be different, such that the second ink portion 23 in the first color state will be covered by the electrophoretic particles 41, while the second ink portion 23 in the second color state will not be covered by the electrophoretic particles 41. On this basis, by adjusting the different voltage values of the first electrode 31 and the second electrode 32 relative to the common electrode 50, the display panel 100 can switch in different color states, thereby meeting the requirements of color display with strong flexibility.

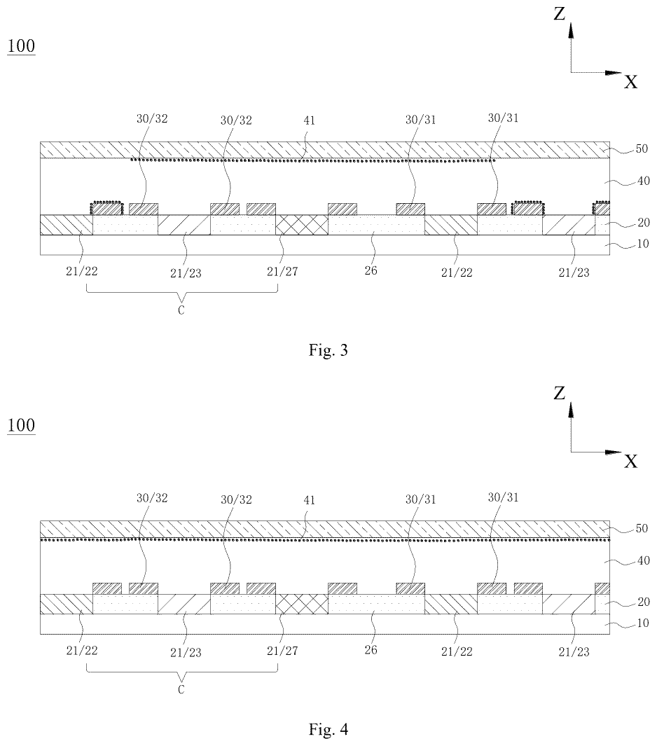

It should be noted that, with reference to FIG. 3, in the actual use of the display panel 100, the display panel 100 often needs to display non-unicolor image information. In this case, for different first ink portions 22, the voltage value relationship between the first electrode 31 and the common electrode 50 corresponding to different first ink portions 22 will also be different. That is, the voltage value of the first electrode 31 at some positions needs to be less than that of the common electrode 50, such that the first ink portion 22 at some positions is not covered by the electrophoretic particles 41, while the voltage value of the first electrode 31 at other positions needs to be greater than that of the common electrode 50, such that the first ink portion 22 at some positions will be covered by the electrophoretic particles 41. The same applies to the different second ink portions 23, and the embodiments of the present application will not repeat this.

In some embodiments, with reference to FIG. 4, the display panel 100 further has a black state, in which the voltage of the common electrode 50 is V7, and V7<0. For example, V7=−15 V.

The expression “black state” mentioned here refers to a state when the display panel 100 displays a black image. In the black state, both the first ink portion 22 and the second ink portion 23 need to be shielded by the electrophoretic particles 41. In this case, the voltage V7 of the common electrode 50 needs to be less than the voltage of both the first electrode 31 and the second electrode 32, and the electrophoretic particles 41 can be repelled by the first electrode 31 and the second electrode 32 and gathered at the common electrode 50, thereby shielding the first ink portion 22 and the second ink portion 23.

On this basis, the embodiment of the present application sets the voltage V7 of the common electrode 50 in the black state to be less than 0, such that the common electrode 50 has the ability to attract the positive electrophoretic particles 41, thereby improving the gathering capability of the electrophoretic particles 41 at the common electrode 50 and improving the shielding effect of the electrophoretic particles 41 on the first ink portion 22 and the second ink portion 23.

Further optionally, on this basis, the voltage of the first electrode 31 and the second electrode 32 in the black state may be set to 0, that is, there may be no signal voltage inside the first electrode 31 and the second electrode 32, thereby reducing the display power consumption of the display panel 100. Alternatively, in other embodiments, the voltage of the first electrode 31 and the second electrode 32 in the black state may not be 0, but may be positive or negative, as long as their voltage is greater than the voltage V7 of the common electrode 50.

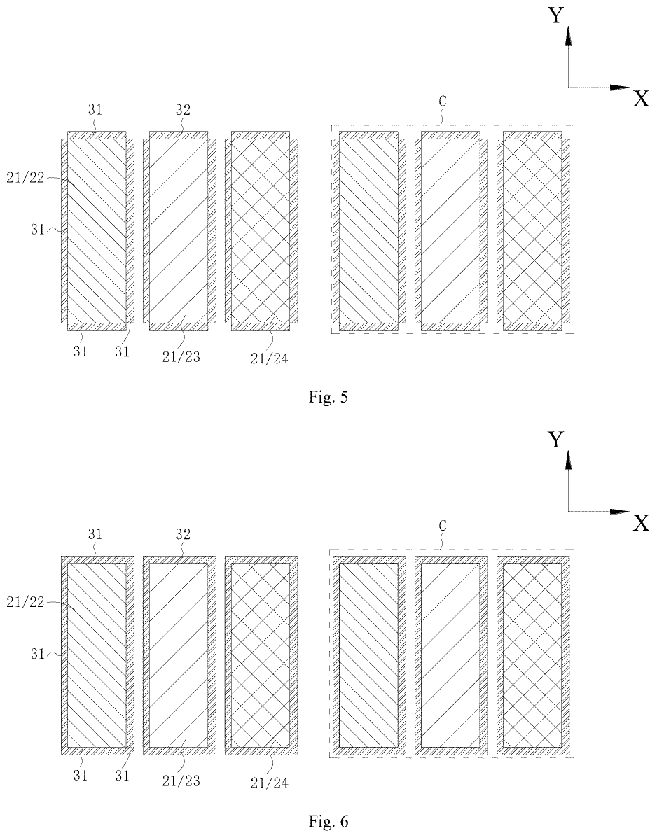

In some embodiments, with reference to FIG. 1 and FIG. 5, the orthographic projections of the plurality of first electrodes 31 corresponding to the first ink portion 22 on the first substrate 10 surround the orthographic projection of the first ink portion 22 on the first substrate 10, the orthographic projections of the plurality of second electrodes 32 corresponding to the second ink portion 23 on the first substrate 10 surround the orthographic projection of the second ink portion 23 on the first substrate 10, and the first electrode 31 is spaced apart from the second electrode 32.

The expression “surround . . . the first ink portion 22” mentioned here indicates that the plurality of first electrodes 31 corresponding to a same first ink portion 22 are disposed at different positions on the periphery of this first ink portion 22, such that the first electrodes 31 are correspondingly disposed on the periphery of this first ink portion 22 in different directions. The plurality of first electrodes 31 corresponding to the same first ink portion 22 may be connected to each other or spaced apart from each other. The same applies to the relative relationship between the second electrodes 32 and the second ink portion 23 and will not be repeated in the embodiments of the present application.

In the embodiments of the present application, the plurality of first electrodes 31 corresponding to the single first ink portion 22 are not merely located at a single position on the periphery of the first ink portion 22, but are disposed at different peripheral positions of the first ink portion 22 in different directions, thereby achieving driving control on the electrophoretic particles 41 corresponding to the first ink portion 22 from multiple angles, improving the control accuracy of the electrophoretic particles 41, and improving the response rate.

Moreover, in the embodiments of the present application, the first electrode 31 and the second electrode 32 are not connected together but spaced apart from each other. As such, the first electrode 31 and the second electrode 32 can be insulated from each other and independently driven by different signal voltages, thereby achieving independent control on the electrophoretic particles 41 relative to the distribution of the first ink portion 22 and the second ink portion 23, to meet the multi-color display requirements of the display panel 100.

In some embodiments, with reference to FIG. 6, the plurality of first electrodes 31 corresponding to the first ink portion 22 are connected to each other; and/or the plurality of second electrodes 32 corresponding to the second ink portion 23 are connected to each other. Further optionally, the plurality of first electrodes 31 corresponding to the first ink portion 22 are connected to each other; and the plurality of second electrodes 32 corresponding to the second ink portion 23 are connected to each other.

Taking the first ink portion 22 as an example, according to different actual needs, some of the first electrodes 31 corresponding to the single first ink portion 22 are connected to each other, while the other of the first electrodes 31 are spaced apart from each other, or all the first electrodes 31 corresponding to the single first ink portion 22 are connected to each other. Optionally, all the first electrodes 31 corresponding to the single first ink portion 22 are connected to each other to form a one-piece structure, which is conducive to reducing the difficulty in manufacturing the first electrodes 31.

From the above content, it can be seen that the shape and size of the first electrode 31 can correspond to those of the first ink portion 22. On this basis, the shape and size of the large electrode structure formed by connecting the plurality of first electrodes 31 can also correspond to those of the first ink portion 22. For example, if the orthographic projection of the first ink portion 22 on the first substrate 10 has a rectangular structure, the orthographic projection of the electrode structure formed by connecting the plurality of first electrodes 31 on the first substrate 10 may have a square ring structure, the square ring structure surrounds the rectangular structure, and two structures may or may not overlap; if the orthographic projection of the first ink portion 22 on the first substrate 10 has a circular structure, the orthographic projection of the electrode structure formed by connecting the plurality of first electrodes 31 on the first substrate 10 may have a circular ring structure, the circular ring structure surrounds the circular structure, and two structures may or may not overlap.

In the embodiments of the present application, the plurality of first electrodes 31 corresponding to a same first ink portion 22 can be connected to each other, which is conducive to reducing the difficulty in manufacturing the first electrodes 31. Meanwhile, in this design, only one signal trace needs to be connected to the first electrodes 31 to meet the signal voltage requirements of the plurality of first electrodes 31, thereby reducing the quantity of signal traces connected to the first electrodes 31 and reducing the layout pressure of signal traces in the display panel 100. In addition, the relationship between the second ink portion 23 and the second electrodes 32 is the same, and will not be limited by the embodiments of the present application.

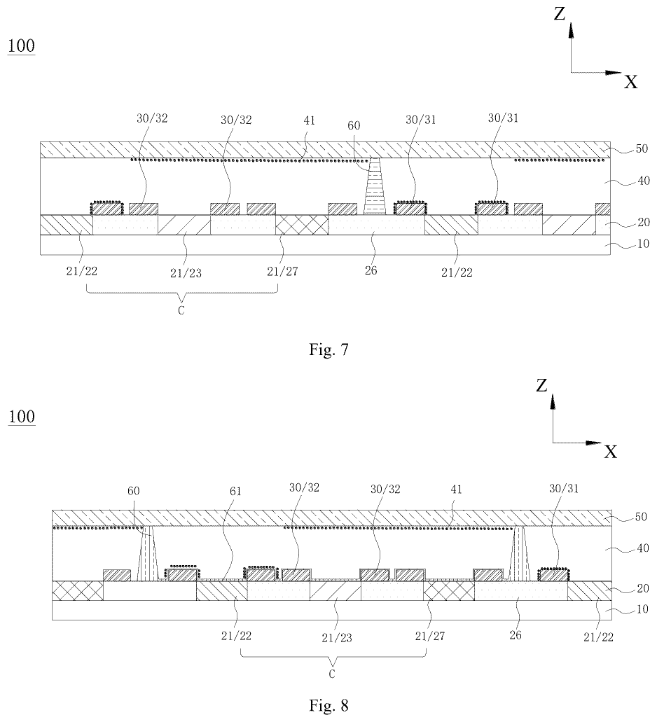

In some embodiments, with reference to FIG. 7, the display panel 100 further includes a support column 60 disposed in the electrophoresis layer 40, and the orthographic projection of the support column 60 on the first substrate 10 is disposed between the orthographic projections of the adjacent ink portions 21 on the first substrate 10. No support column 60 is provided between some adjacent ink portions 21.

The support column 60 is a component used for providing support in the display panel 100. The support column 60 is disposed in the electrophoresis layer 40, that is, the support column 60 may be disposed on the same layer as the electrophoretic particles 41. The support column 60 can reduce the deformation of the electrophoresis layer 40, reduce the risk of movement of the electrophoretic particles 41 due to the deformation of the electrophoresis layer 40, and improve the use reliability of the display panel 100.

It should be noted that, as shown in FIG. 7, the support column 60 provided in the embodiments of the present application can be applied to an electrophoretic display panel 100 with a cofferdam structure. In this case, a plurality of support columns 60 can define and form a plurality of different regions that are independent of each other, and the electrophoretic particles 41 located in the single region, blocked by the support columns 60, cannot move to other adjacent regions. Alternatively, as shown in FIG. 8, the support structure provided in the embodiments of the present application can be applied to an electrophoretic display panel 100 with a micro-cup structure. In this case, the display panel 100 further includes a support layer 61, and two adjacent support columns 60 are connected to the support layer 61 and made of the same material. As such, adjacent two of the support columns 60 and the support layer 61 can jointly form a micro-cup structure used for accommodating a plurality of electrophoretic particles 41. The micro-cup structure can also prevent the risk of excessive movement of the electrophoretic particles 41 and improve the operational reliability of the display panel 100.

In addition, the specific position of the support column 60 relative to the ink portion 21 and the pixel electrode 30 is not limited in the embodiments of the present application. The support column 60 may be attached to the surface of the pixel electrode 30 away from the first substrate 10, or the support column 60 may be attached to the surface of the ink portion 21 away from the first substrate 10, or the support column 60 may be disposed on the same layer as at least one of the ink portion 21 and the pixel electrode 30.

From the above content, it can be seen that a single first ink portion 22 corresponds to a plurality of first electrodes 31 for controlling the positions of the electrophoretic particles 41 relative to the first ink portion 22, and a single second ink portion 23 corresponds to a plurality of second electrodes 32 for controlling the positions of the electrophoretic particles 41 relative to the second ink portion 23. On this basis, considering that one ink portion 21 usually corresponds to a plurality of first electrodes 30, the electric field structure formed by the pixel electrodes 30 and the common electrode 50 can greatly adjust and control the distribution state of the electrophoretic particles 41. In view of this, no support columns 60 may be provided between some adjacent ink portions 21, thereby reducing the orthographic projection size of the plurality of support columns 60 on the first substrate 10.

Further, in the embodiments of the present application, the support columns 60 can provide support for the electrophoresis layer 40 and reduce the risk of excessive movement of the electrophoretic particles 41, thereby improving the use reliability of the display panel 100. Meanwhile, because no support columns 60 are provided between some adjacent ink portions 21, the orthographic projection size of the plurality of support columns 60 on the first substrate 10 can be reduced, and the occupation of space by the support columns 60 on the ink portions 21 or the pixel electrodes 30 can be reduced, thereby improving the resolution of the display panel 100, or improving the control effect of the pixel electrodes 30 on the electrophoretic particles 41, and improving the response rate of the electrophoretic particles 41.

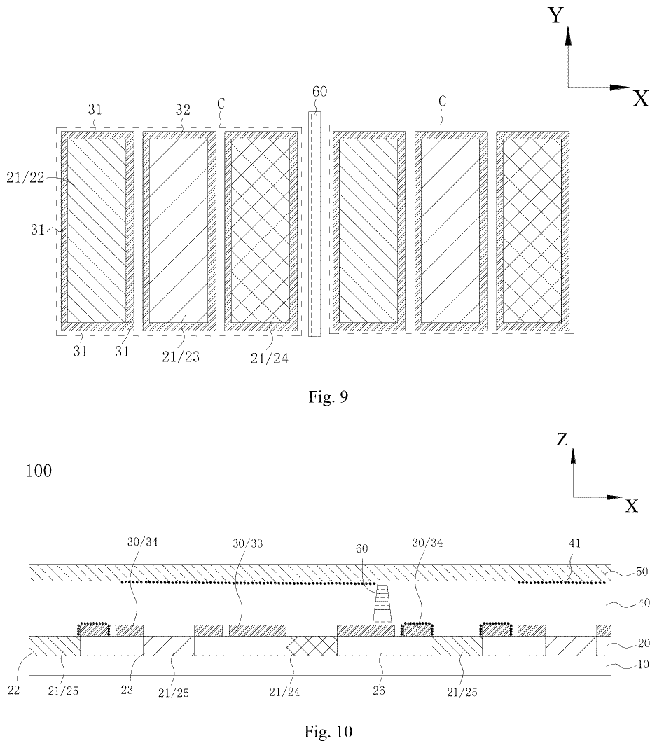

In some embodiments, with reference to FIG. 7 to FIG. 9, the colored ink portions 21 include a plurality of repeat units C arranged in an array, the repeat unit C includes at least one first ink portion 22 and at least one second ink portion 23, and the orthographic projection of the support column 60 on the first substrate 10 is located between the orthographic projections of the adjacent repeat units C on the first substrate 10.

The repeat unit C is a minimum repeat unit composed of a plurality of adjacent ink portions 21, and the plurality of repeat units C are arranged in an array. For example, the plurality of repeat units C are arranged in an array in a first direction X and a second direction Y respectively, where the first direction X, the second direction Y, and the thickness direction Z of the display panel 100 intersect each other. The repeat unit C includes at least the first ink portion 22 and the second ink portion 23, where the single repeat unit C may include only one first ink portion 22 or a plurality of first ink portions 22. Similarly, the single repeat unit C may include only one second ink portion 23 or a plurality of second ink portions 23. And the single repeat unit C may include only two color types of ink portions 21, the first ink portion 22 and the second ink portion 23, or may further include ink portions 21 of other colors. The embodiments of the present application do not limit this.

In the embodiments of the present application, considering that the distance between the adjacent repeat units C is often greater than that between the adjacent ink portions 21 in the single repeat unit C, the support column 60 is correspondingly disposed in the region between the adjacent repeat units C, which is conducive to improving the layout rationality between the support column 60 and the ink portion 21, and also increasing the distance between the support column 60 and the ink portion 21 located in the repeat unit C, thereby reducing the amount of light reflected by the ink portion 21 to the support column 60, reducing the adverse effect of the support column 60 on light, and improving the display effect.

In some optional embodiments, the orthographic projections of the plurality of support columns 60 on the first substrate 10 surround the orthographic projection of the single repeat unit C on the first substrate 10, such that the support columns 60 can reduce the risk of cross-region movement of the electrophoretic particles 41 in the regions where different repeat units C are located, to improve the display reliability of the display panel 100.

In some embodiments, with reference to FIG. 10, the plurality of ink portions 21 include first-type ink portions 24 and second-type ink portions 25, the plurality of pixel electrodes 30 include first-type electrodes 33 corresponding to the first-type ink portions 24 and second electrodes 32 corresponding to the second-type ink portions 25, the orthographic projection of the first-type ink portion 24 on the first substrate 10 is located between the orthographic projections of the adjacent first-type electrodes 33 on the first substrate 10, and the orthographic projection of the second-type ink portion 25 on the first substrate 10 is located between the orthographic projections of two of the second-type electrodes 34 on the first substrate 10.

The support column 60 is located on the side of the first-type electrode 33 away from the first substrate 10, and the orthographic projection of the second-type electrode 34 on the first substrate 10 does not overlap with the orthographic projection of the support column 60 on the first substrate 10. The orthographic projection area of the first-type electrode 33 on the first substrate 10 is greater than that of the second-type electrode 34 on the first substrate 10.

The first-type ink portion 24 is the ink portion 21 closest to the support column 60 among the plurality of ink portions 21. One support column 60 may correspond to one or more first-type ink portions 24. For example, if the orthographic projection of one support column 60 on the first substrate 10 has a point-like structure, only one first-type ink portion 24 corresponds to the support column 60; if the orthographic projection of the single support column 60 on the first substrate 10 has a strip-like structure extending along the first direction X, the corresponding first-type ink portions 24 are a plurality of adjacent first ink portions 22 located on one side of the support column 60 along the second direction Y. Further, considering that there is often a plurality of support columns 60 in the display panel 100, there is often a plurality of first-type ink portions 24.

On this basis, the second-type ink portions 25 are the other ink portions 21 among the plurality of ink portions 21 than the first-type ink portions 24. It should be noted that, unlike the first ink portion 22 and the second ink portion 23, different first ink portions 22 correspondingly include ink portions 21 of the same color, while different first-type ink portions 24 may correspondingly include ink portions 21 of the same color or include ink portions 21 of different colors. Similarly, different second ink portions 25 may correspondingly include ink portions 21 of the same color or include ink portions 21 of different colors.

One first-type ink portion 24 may be correspondingly provided with a plurality of first-type electrodes 33, and the plurality of first-type electrodes 33 are correspondingly located at different positions on the periphery of the first-type ink portion 24. Depending on different actual needs, the orthographic projection of the first-type electrode 33 on the first substrate 10 may overlap with the orthographic projection of the first-type ink portion 24 on the first substrate 10, or the orthographic projection of the first-type electrode 33 on the first substrate 10 may be completely located outside the orthographic projection of the first-type ink portion 24 on the first substrate 10, as long as the orthographic projection of the first-type ink portion 24 on the first substrate 10 is at least partially located between the orthographic projections of two of the first-type electrodes 33 on the first substrate 10. The two first-type electrodes 33 mentioned here refer to two first electrodes 31 adjacent in one direction. The orthographic projections of the first-type ink portion 24 and the two first-type electrodes 33 on the first substrate 10 may or may not overlap. In addition, the relationship between the second-type ink portion 25 and the second-type electrodes 34 is the same, and will not be repeated by the embodiments of the present application.

Further, because the support column 60 is relatively close to the first-type ink portion 24, the support column 60 can be correspondingly disposed on the side of the first-type electrode 33 away from the first substrate 10, that is, the orthographic projection of the support column 60 on the first substrate 10 overlaps with the orthographic projection of the first-type electrode 33 on the first substrate 10. Because the support column 60 is relatively close to the second-type ink portion 25, the orthographic projection of the second-type electrode 34 on the first substrate 10 does not overlap with the orthographic projection of the support column 60 on the first substrate 10, that is, the orthographic projection of the second-type electrode 34 on the first substrate 10 is located outside the orthographic projection of the support column 60 on the first substrate 10.

On this basis, the support column 60 may shield a portion of the first-type electrode 33, such that the first-type electrode 33 cannot adsorb the electrophoretic particles 41 in some regions on the surface away from the first substrate 10, and some electrophoretic particles 41 are prone to suspension above the first-type ink portion 24 when the first-type electrode 33 adsorbs the electrophoretic particles 41.

In view of this, the embodiments of the present application differentiate the sizes of the first-type electrode 33 and the second-type electrode 34, such that the orthographic projection area of the first-type electrode 33 on the first substrate 10 is greater than that of the second-type electrode 34 on the first substrate 10. According to this design, the surface of the first-type electrode 33 away from the first substrate 10 can still have a larger area for adsorbing the electrophoretic particles 41, thereby improving the adsorption ability of the first-type electrode 33 to the electrophoretic particles 41, reducing the quantity of the electrophoretic particles 41 suspended above the first-type ink portion 24 when the first-type electrode 33 adsorbs the electrophoretic particles 41, and improving the display reliability of the display panel 100 at the first-type ink portion 24.

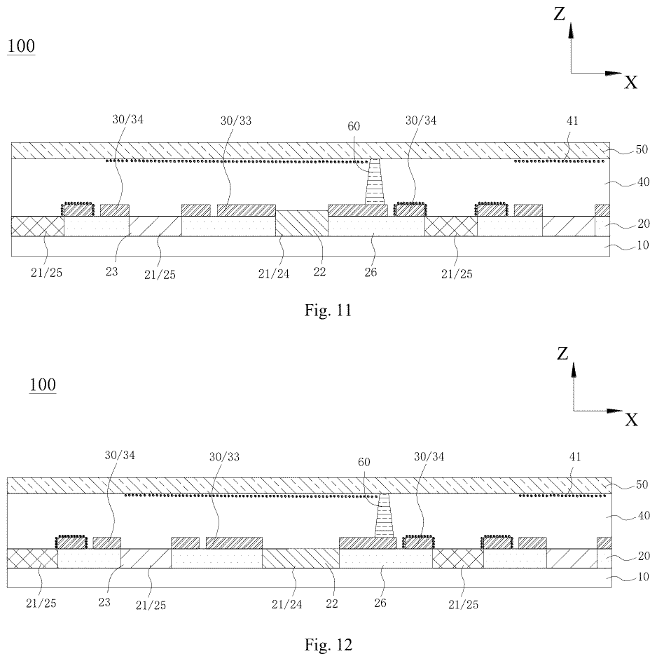

In some embodiments, with reference to FIG. 11 and FIG. 12, the plurality of ink portions 21 include first-type ink portions 24 and second-type ink portions 25, the plurality of pixel electrodes 30 include first-type electrodes 33 corresponding to the first ink portions 22 and second electrodes 32 corresponding to the second-type ink portions 25, the orthographic projection of the first-type ink portion 24 on the first substrate 10 is located between the orthographic projections of two of the first-type electrodes 33 on the first substrate 10, and the orthographic projection of the second-type ink portion 25 on the first substrate 10 is located between the orthographic projections of two of the second-type electrodes 34 on the first substrate 10.

The support column 60 is located on the side of the first-type electrode 33 away from the first substrate 10, and the orthographic projection of the second-type electrode 34 on the first substrate 10 does not overlap with the orthographic projection of the support column 60 on the first substrate 10. The thickness of the first-type ink portion 24 is greater than that of the second-type ink portion 25, and/or the orthographic projection area of the first-type ink portion 24 on the first substrate 10 is greater than that of the second-type ink portion 25 on the first substrate 10.

In some optional embodiments, the thickness of the first-type ink portion 24 is greater than that of the second-type ink portion 25, and the orthographic projection area of the first-type ink portion 24 on the first substrate 10 is greater than that of the second-type ink portion 25 on the first substrate 10.

It should be noted that the expression “thickness of the first-type ink portion 24” mentioned here refers to an average size of the first-type ink portion 24 in the thickness direction Z of the display panel 100. The sizes of different regions in the first-type ink portion 24 in the thickness direction Z of the display panel 100 may be the same or different. The same applies to the expression “thickness of the second-type ink portion 25” and will not be limited by the embodiments of the present application.

For the ink portion 21, the reflection brightness corresponding to the ink portion 21 is positively correlated with its thickness, and the reflection brightness corresponding to the ink portion 21 is also positively correlated with its orthographic projection area. On this basis, under the same light irradiation, the first-type ink portion 24 can have higher reflection brightness than the second-type ink portion 25.

When the support column 60 is correspondingly located on the side of the first-type electrode 33 away from the first substrate 10, the support column 60 not only affects the ability of the first-type electrode 33 to adsorb the electrophoretic particles 41, but also affects the display effect of the display panel 100 at the first-type ink portion 24. Specifically, when the first-type electrode 33 adsorbs the electrophoretic particles 41, ambient light can propagate to the first-type ink portion 24 and be reflected to turn into light of a specific color. However, the support column 60 is relatively close to the first-type ink portion 24, and the support column 60 has low light transmittance, so the reflected light formed by the first-type ink portion 24, exiting partially obliquely, will propagate to the support column 60 and be absorbed. As such, the corresponding wide-angle brightness of the display panel 100 at the first-type ink portion 24 decreases, thereby causing uneven wide-angle display.

In view of this, the embodiments of the present application differentiate the sizes of the first-type ink portion 24 and the second-type ink portion 25, such that the orthographic projection area of the first-type ink portion 24 on the first substrate 10 is greater than that of the second-type ink portion 25 on the first substrate 10, or such that the thickness of the first-type ink portion 24 is greater than that of the second-type ink portion 25. Regardless of which scheme, the first-type ink portion 24 has a stronger light reflection effect than the second-type ink portion 25, thereby increasing the wide-angle light brightness of the display panel 100 at the first-type ink portion 24, reducing the risk of uneven wide-angle display caused by the support column 60, and improving the display reliability of the display panel 100.

In some embodiments, the first-type ink portion 24 includes a green ink portion 21.

From the above content, it can be seen that the support column 60 mainly affects the wide-angle light of the display panel 100 at the first-type ink portion 24, thereby causing uneven wide-angle display. On this basis, considering that the human eye is more sensitive to green light and the display panel 100 is mostly used in front-view observation scenarios, the first-type ink portion 24 includes the green ink portion 21 in the embodiment of the present applications, which is conducive to further increasing the brightness of green light emitted by the display panel 100 in the front-view observation scenarios, thereby improving the display perception of the display panel 100 in the front-view observation scenarios.

It should be noted that, considering the plurality of first-type ink portions 24, different first-type ink portions 24 may all include green ink portions 21, or only some first-type ink portions 24 may include green ink portions 21. Optionally, each first-type ink portion 24 includes a green ink portion 21, that is, the support column 60 is correspondingly disposed at a position near the periphery of the green ink portion 21.

In some embodiments, the first ink portion 22 includes a green ink portion 21, and the second ink portion 23 includes a red ink portion 21 or a blue ink portion 21.

In the embodiments of the present application, green, red, and blue jointly form three primary colors, which are three basic colors that cannot be further decomposed in color. Considering that the human eye is more sensitive to green, the first ink portion 22 includes the green ink portion 21, and the second ink portion 23 includes the red ink portion 21 or the blue ink portion 21. By mutual combination of reflected light corresponding to the first ink portion 22 and the second ink portion 23, the display panel 100 produces other different colors, thereby satisfying the multi-color display effect of the display panel 100.

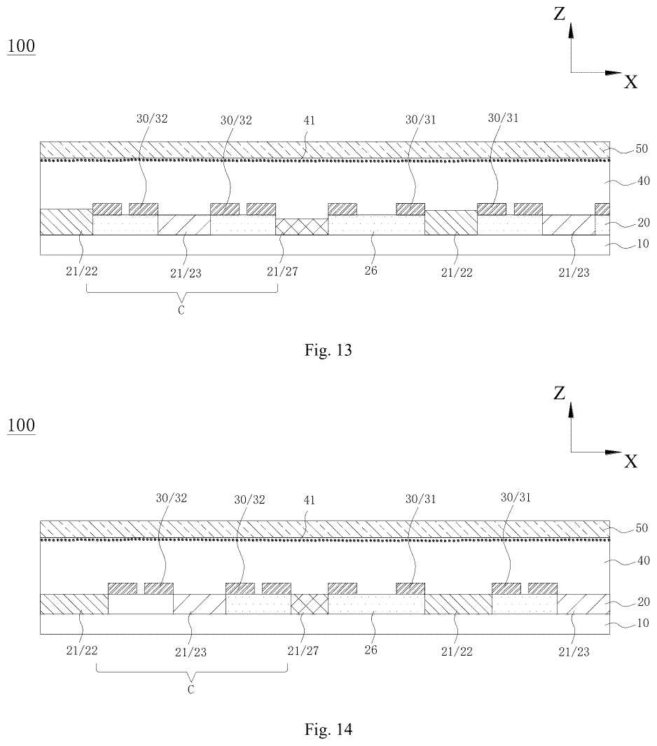

In some embodiments, with reference to FIG. 13 and FIG. 14, the thickness of the first ink portion 22 is greater than that of the second ink portion 23; and/or the orthographic projection area of the first ink portion 22 on the first substrate 10 is greater than that of the second ink portion 23 on the first substrate 10.

In some optional embodiments, the thickness of the first ink portion 22 is greater than that of the second ink portion 23, and the orthographic projection area of the first ink portion 22 on the first substrate 10 is greater than that of the second ink portion 23 on the first substrate 10.

For the ink portion 21, the reflection brightness corresponding to the ink portion 21 is positively correlated with its thickness, and the reflection brightness corresponding to the ink portion 21 is also positively correlated with its orthographic projection area. On this basis, under the same light irradiation, the first ink portion 22 can have higher reflection brightness than the second ink portion 23.

In the embodiments of the present application, considering that the human eye is usually more sensitive to green, the orthographic projection area of the first ink portion 22 on the first substrate 10 is greater than that of the second ink portion 23 on the first substrate 10, or the thickness of the first-type ink portion 24 is greater than that of the second ink portion 23. As such, the first ink portion 22 has a stronger light reflection effect than the second ink portion 23, thereby increasing the brightness of the display panel 100 at the first ink portion 22 and improving the use experience of the display panel 100.

In some embodiments, as shown in FIG. 13 and FIG. 14, the plurality of ink portions 21 include third ink portions 27, the second ink portion 23 includes a red ink portion 21, the third ink portion 27 includes a blue ink portion 21, and the thickness of the third ink portion 27 is less than that of at least one of the first ink portion 22 and the second ink portion 23; and/or the orthographic projection area of the third ink portion 27 on the first substrate 10 is less than that of at least one of the first ink portion 22 and the second ink portion 23 on the first substrate 10.

In addition to the first ink portion 22 and the second ink portion 23, the plurality of ink portions 21 may further include the third ink portion 27. The first ink portion 22, the second ink portion 23, and the third ink portion 27 include the green ink portion 21, the red ink portion 21, and the blue ink portion 21, respectively. On this basis, considering the potential harm of blue light to the eye, in the embodiments of the present application, the thickness of the third ink portion 27 is less than that of at least one of the first ink portion 22 and the second ink portion 23, or the orthographic projection area of the third ink portion 27 on the first substrate 10 is less than that of at least one of the first ink portion 22 and the second ink portion 23 on the first substrate 10, such that the third ink portion 27 has a smaller light reflection capability relative to at least one of the first ink portion 22 and the second ink portion 23, the blue light brightness of the display panel 100 is reduced, and the eye protection capability of the display panel 100 is improved.

In some optional embodiments, the thicknesses of the first ink portion 22, the second ink portion 23, and the third ink portion 27 sequentially decease; and/or the orthographic projection areas of the first ink portion 22, the second ink portion 23, and the third ink portion 27 on the first substrate 10 sequentially decease. This design can, on the one hand, increase the green light brightness of the display panel 100 to improve the use experience of the display panel 100, and on the other hand, decrease the blue light brightness of the display panel 100 to improve the eye protection capability of the display panel 100.

In some embodiments, as shown in FIG. 1, the colored ink layer 20 further includes connection portions 26, each of which is located between the adjacent ink portions 21, and the pixel electrode 30 is located on the side of the connection portion 26 away from the first substrate 10.

The connection portion 26 is a structure used in the colored ink layer 20 to connect the adjacent different ink portions 21, and the connection portion 26 can be used to space the adjacent different ink portions 21 apart from each other, so as to reduce the risk of material mixing between different ink portions 21 and improve the color accuracy of reflected light corresponding to the single ink portion 21. Unlike the ink portion 21, the connection portion 26 is not used to reflect ambient light. Therefore, compared to the ink portion 21, the connection portion 26 has more material options. For example, the connection portion 26 may include a colored ink material, or the connection portion 26 may include a black or white ink material, or the connection portion 26 may include other materials except ink materials, which is not limited by the embodiments of the present application.

In addition, the dimensional relationship between the connection portion 26 and the ink portion 21 may have various forms. For example, the thickness of the connection portion 26 may be greater than, equal to, or less than that of the ink portion 21. Optionally, the thickness of the connection portion 26 may be the same as that of the ink portion 21, such that the surfaces of the connection portion 26 and the ink portion 21 away from the first substrate 10 can jointly form a flat surface, thereby reducing the difficulty in manufacturing other structures formed after the colored ink layer 20.

The pixel electrode 30 is located on the side of the connection portion 26 away from the first substrate 10, that is, the orthographic projection of the pixel electrode 30 on the first substrate 10 overlaps with the orthographic projection of the connection portion 26 on the first substrate 10, where the orthographic projection of the pixel electrode 30 on the first substrate 10 may be located within the orthographic projection of the connection portion 26 on the first substrate 10, or the orthographic projection of the pixel electrode 30 on the first substrate 10 may partially overlap with the orthographic projection of the ink portion 21 on the first substrate 10.

In the embodiments of the present application, the ink portion 21 includes a first bottom surface facing the first substrate 10, and the pixel electrode 30 includes a second bottom surface facing the first substrate 10. The connection portion 26 enables the second bottom surface to be located on the side of the first bottom surface away from the first substrate 10. As such, the pixel electrode 30 can extend beyond the surface of the ink portion 21 away from the first substrate 10 without increasing the thickness of the pixel electrode 30, that is, at least a portion of the pixel electrode 30 on a side wall does not abut against the ink portion 21, but is exposed within the electrophoresis layer 40. On this basis, when the pixel electrode 30 needs to adsorb the electrophoretic particles 41 to meet the reflection requirements of the corresponding ink portion 21, the pixel electrode 30 can not only adsorb the electrophoretic particles 41 on the surface away from the first substrate 10, but also can adsorb at least some electrophoretic particles 41 on the side wall, thereby improving the adsorption ability of the pixel electrode 30 to the electrophoretic particles 41. Meanwhile, the distance between the electrophoretic particles 41 and the pixel electrode 30 decreases, thereby improving the response rate of the electrophoretic particles 41 and the display effect of the display panel 100.

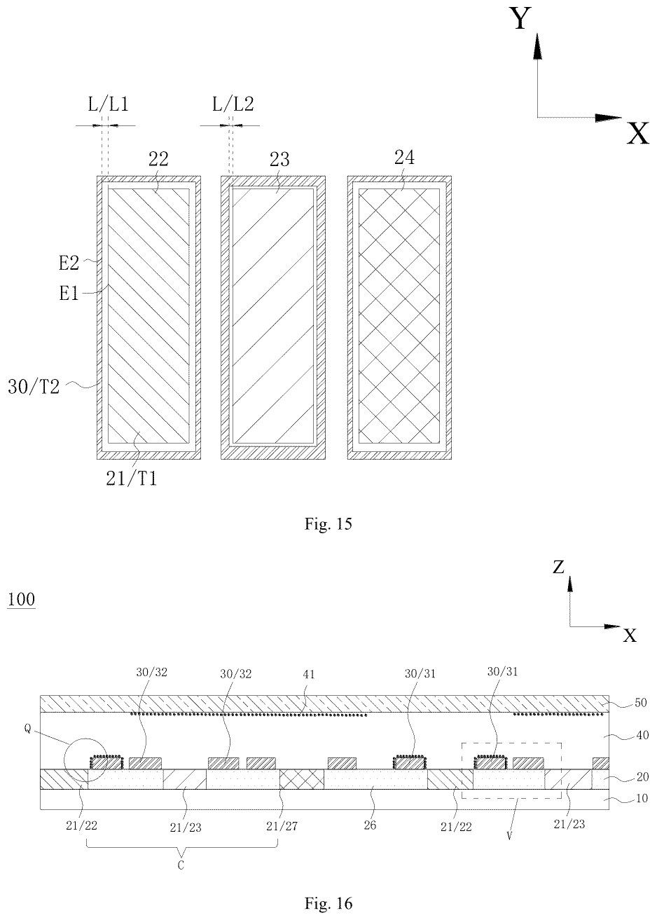

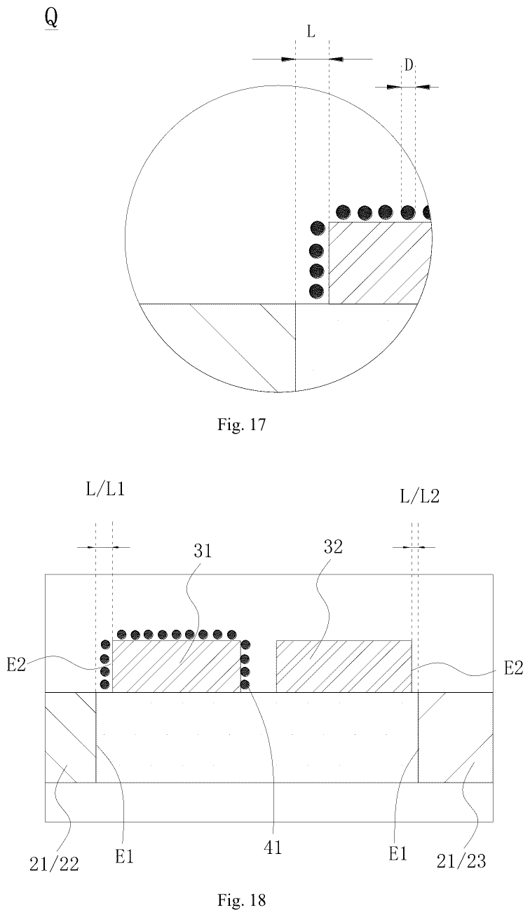

In some embodiments, with reference to FIG. 15 to FIG. 17, the ink portion 21 has a first orthographic projection T1 on the first substrate 10, the pixel electrode 30 has a second orthographic projection T2 on the first substrate 10, and the second orthographic projection T2 does not overlap with the first orthographic projection T1. In other words, the second orthographic projection T2 is located outside the first orthographic projection T1, and the second orthographic projection T2 and the first orthographic projection T1 are spaced apart from each other.

In the embodiments of the present application, the second orthographic projection T2 corresponding to the pixel electrode 30 does not overlap with the first orthographic projection T1 corresponding to the ink portion 21, such that the pixel electrode 30 does not cover or shield the ink portion 21. On this basis, ambient light can be irradiated to various positions on the surface of the ink portion 21 away from the first substrate 10 and reflected, thereby increasing the intensity of reflected light and improving the display brightness and display effect of the display panel 100.

In some embodiments, the first orthographic projection T1 has a first edge E1 facing the second orthographic projection T2, the second orthographic projection T2 has a second edge E2 facing the first orthographic projection T1, the distance between the first edge E1 and the second edge E2 is L, and the diameter of the electrophoretic particle 41 is D, where L≥D.

It should be noted that the expression “first edge E1 and second edge E2” mentioned here refer to: for the single ink portion 21 and the corresponding pixel electrode 30, the first edge E1 is an edge of the first orthographic projection T1 of the ink portion 21 facing the second orthographic projection T2 of the pixel electrode 30, and the second edge E2 is an edge of the second orthographic projection T2 of the pixel electrode 30 facing the first orthographic projection T1 of the ink portion 21. And the expression “diameter D of the electrophoretic particle 41” mentioned here refers to: if the electrophoretic particle 41 has a regular spherical structure, D is the diameter of the spherical structure; if the electrophoretic particle 41 has an irregular spherical or other structure, D is the maximum cross-sectional length of the structure.

In addition, both the first edge E1 and the second edge E2 may have a straight line structure, or at least one of the first edge E1 and the second edge E2 may include an arc or zigzag line structure, and the first edge E1 and the second edge E2 may be or may not be parallel to each other. The embodiments of the present application do not limit this. The expression “distance L between the first edge E1 and the second edge E2” refers to the maximum distance between the first edge E1 and the second edge E2 in the arrangement direction of the first orthographic projection T1 and the second orthographic projection T2.

In the embodiments of the present application, considering that at least some electrophoretic particles 41 are adsorbed on the side wall of the pixel electrode 30 when the electrophoretic particles 41 do not shield the ink portion 21, the distance L between the first edge E1 and the second edge E2 is greater than the diameter D of the electrophoretic particles 41, which can reduce the shielding effect of the electrophoretic particles 41 adsorbed on the side wall of the pixel electrode 30 on the ink portion 21, thereby increasing the intensity of reflected light and improving the display brightness and display effect of the display panel 100.

In some embodiments, with reference to FIG. 15 and FIG. 18, the distance between the first edge E1 of the first ink portion 22 and the second edge E2 of the first electrode 31 is L1, and the distance between the first edge E1 of the second ink portion 23 and the second edge E2 of the second electrode 32 is L2, where L1>L2.

The first ink portion 22 and the second ink portion 23 are ink portions 21 of different colors respectively, the first electrode 31 is the pixel electrode 30 corresponding to the first ink portion 22, and the second electrode 32 is the pixel electrode 30 corresponding to the second ink portion 23. On this basis, L1 represents the distance between the first edge E1 of the first ink portion 22 and the second edge E2 of the first electrode 31, while L2 represents the distance between the first edge E1 of the second ink portion 23 and the second edge E2 of the second electrode 32.

Further, in the embodiments of the present application, the distance L1 is greater than the distance L2, that is, the distance between the first ink portion 22 and the first electrode 31 in a direction parallel to the plane where the first substrate 10 is located is greater than the distance between the second ink portion 23 and the second electrode 32 in the direction parallel to the plane where the first substrate 10 is located. As such, when both the first electrode 31 and the second electrode 32 adsorb the electrophoretic particles 41, the influence of the electrophoretic particles 41 located on the side wall of the first electrode 31 on the first ink portion 22 can be less than the influence of the electrophoretic particles 41 located on the side wall of the second electrode 32 on the second ink portion 23, which is conducive to increasing the reflected light intensity of the display panel 100 at the first ink portion 22, such that the reflected light intensities corresponding to the first ink portion 22 and the second ink portion 23 are different to meet different requirements of the display panel 100.

Optionally, considering that the human eyes are more sensitive to green light, the first ink portion 22 may include the green ink portion 21, and the second ink portion 23 may include either the blue ink portion 21 or the red ink portion 21. On this basis, in the embodiments of the present application, the distance L1 is greater than the distance L, thereby increasing the reflection brightness of green light and improving the use experience of the display panel 100.

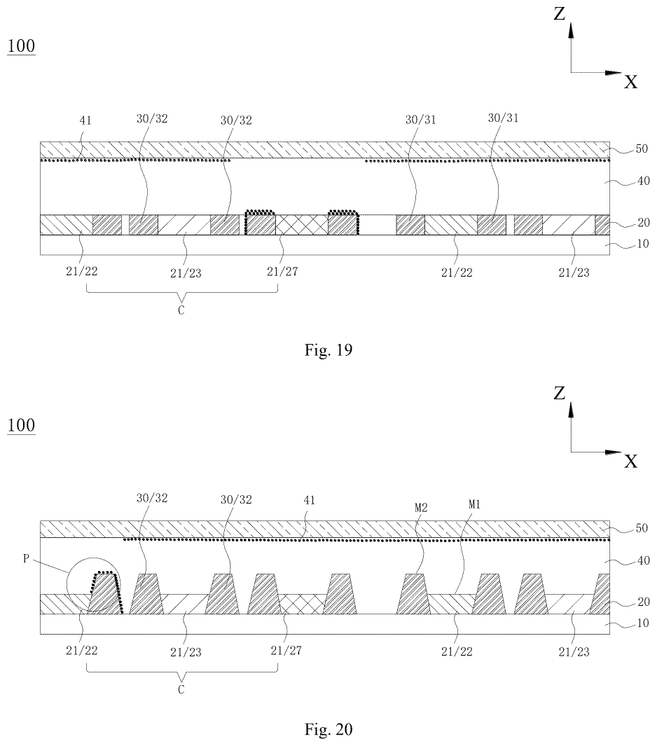

In some embodiments, with reference to FIG. 19, the pixel electrode 30 and the ink portion 21 are disposed in the same layer. In other words, at least a portion of the side wall of the pixel electrode 30 can abut against the side wall of the ink portion 21.

It should be noted that there are various dimensional relationships between the pixel electrode 30 and the ink portion 21. For example, the thickness of the pixel electrode 30 may be less than or equal to that of the ink portion 21, or the thickness of the pixel electrode 30 may be greater than that of the ink portion 21. Further, the surface of the pixel electrode 30 away from the first substrate 10 may be flush with the surface of the ink portion 21 away from the first substrate 10, or located on the surface of the ink portion 21 away from the first substrate 10 towards or away from one side of the first substrate 10.

In the embodiments of the present application, because the pixel electrode 30 and the ink portion 21 are disposed in the same layer, the adjacent different ink portions 21 can be spaced apart by the pixel electrode 30, thereby reducing the risk of material mixing between different ink portions 21, improving the color accuracy of reflected light corresponding to the single ink portion 21, and improving the display effect of the display panel 100.

In some embodiments, with reference to FIG. 20, in a direction perpendicular to the plane where the first substrate 10 is located, the distance between the first substrate 10 and the surface of the pixel electrode 30 away from the first substrate 10 is greater than that between the first substrate 10 and the surface of the ink portion 21 away from the first substrate 10. The direction perpendicular to the plane where the first substrate 10 is located is the thickness direction Z of the first substrate 10.

With reference to the accompanying drawing, the surface of the ink portion 21 away from the first substrate 10 is a first top surface M1, the surface of the pixel electrode 30 away from the first substrate 10 is a second top surface M2, and the second top surface M2 is located on the side of the first top surface M1 away from the first substrate 10. On this basis, at least a portion of the pixel electrode 30 on the side wall does not abut against the ink portion 21, but is exposed within the electrophoresis layer 40. Therefore, when the pixel electrode 30 needs to adsorb the electrophoretic particles 41 to meet the reflection requirements of the corresponding ink portion 21, the pixel electrode 30 can not only adsorb the electrophoretic particles 41 away from the second top surface M2, but also can adsorb at least some electrophoretic particles 41 on the side wall, thereby improving the adsorption ability of the pixel electrode 30 to the electrophoretic particles 41. Meanwhile, the distance between the electrophoretic particles 41 and the pixel electrode 30 decreases, thereby improving the response rate of the electrophoretic particles 41 and the display effect of the display panel 100.

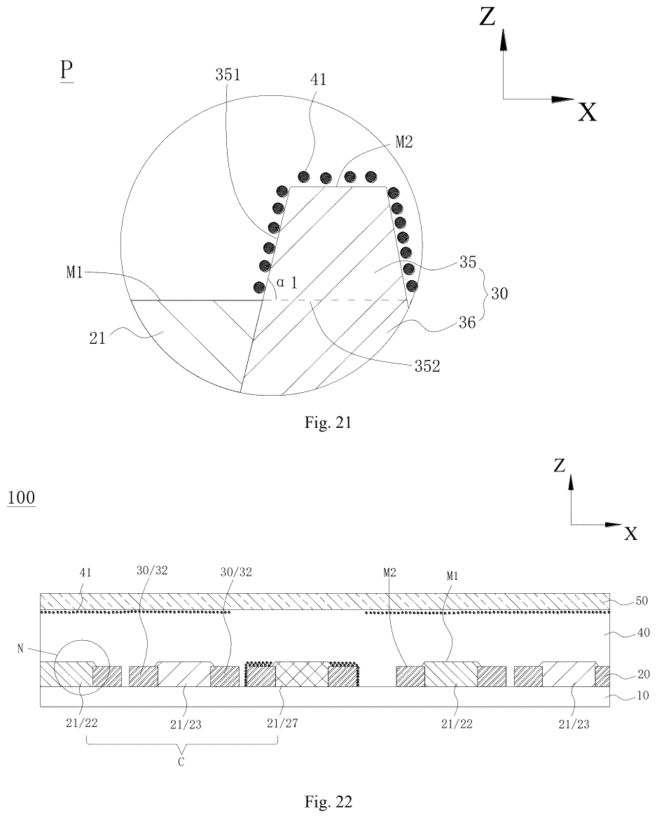

In some embodiments, with reference to FIG. 20 and FIG. 21, the pixel electrode 30 includes a first protrusion 35 located on the side of the ink portion 21 away from the first substrate 10; in a direction parallel to the plane where the first substrate 10 is located, the first protrusion 35 has a first side wall 351; and in the direction perpendicular to the plane where the first substrate 10 is located, the first protrusion 35 has a first bottom wall 352 facing the first substrate 10; where the angle between the first side wall 351 and the first bottom wall 352 is α1, and 0<α1<90°.

The expression “parallel to the plane where the first substrate 10 is located” mentioned here refers to a direction perpendicular to the thickness direction Z of the first substrate 10. In the direction parallel to the plane where the first substrate 10 is located, ink portion 21 is at least partially located between two corresponding pixel electrodes 30.

The first protrusion 35 is a partial structure of the pixel electrode 30 that extends beyond the surface of the ink portion 21 away from the first substrate 10. With reference to FIG. 20, the pixel electrode 30 further includes a first body portion the 36 in addition to the first protrusion 35. The first body portion is a partial structure of the pixel electrode 30 that does not extend beyond the surface of the ink portion 21 away from the first substrate 10, and the first body portion 36 is connected with the first protrusion 35 into a whole.

The first bottom wall 352 and the first side wall 351 are walls of the first protrusion 35 in different directions. The first bottom wall 352 may be parallel to the plane where the first substrate 10 is located, that is, the first bottom wall 352 may be perpendicular to the thickness direction Z of the first substrate 10. The first side wall 351 may have various forms. For example, the first side wall 351 may have a planar structure, or the first side wall 351 may have an arc structure.

On this basis, if both the first bottom wall 352 and the first side wall 351 have planar structures, α1 represents the angle between two planar structures; if the first bottom wall 352 has a planar structure and the first side wall 351 has an arc structure, α1 represents the angle between the planar structure and a tangent plane of the arc structure at a position in contact with the planar structure.

Further, if 0<α1<90°, it indicates that the first side wall 351 of the pixel electrode 30 is inclined away from the adjacent corresponding ink portion 21 in the direction perpendicular to the plane where the first substrate 10 is located and away from the first substrate 10. Under this design, a portion of the wide-angle light reflected by the ink portion 21 can exit the display panel 100 along the slope of the first side wall 351, without irradiating the pixel electrode 30 and being absorbed, thereby increasing the display brightness of the display panel 100 in wide-angle observation cases and expanding the usage range of the display panel 100.

It should be noted that the specific value of α1 is not limited by the embodiments of the present application. Optionally, α1 may be one of 5°, 10°, 15°, 20°, 30°, 35°, 45°, 55°, 60°, 75°, and 80°. The first body portion may also include a bottom wall structure and a side wall structure, and the relationship between the bottom wall structure and the side wall structure may be the same as or different from the relationship between the first bottom wall 352 and the first side wall 351. Optionally, the corresponding side wall structure of the first body portion is coplanar with the first side wall 351 to form a continuous planar or curved structure.

In some embodiments, with reference to FIG. 22, in the direction perpendicular to the plane where the first substrate 10 is located, the distance between the first substrate 10 and the surface of the ink portion 21 away from the first substrate 10 is greater than that between the first substrate 10 and the surface of the pixel electrode 30 away from the first substrate 10.

From the accompanying drawings, it can be seen that the first top surface M1 is located on the side of the second top surface M2 away from the first substrate 10, and the pixel electrode 30 does not completely shield the side wall of the ink portion 21, that is, at least a portion of the ink portion 21 at its side wall does not abut against the ink portion 21, but is exposed within the electrophoresis layer 40. On this basis, when the ink portion 21 needs to reflect light to meet display requirements, ambient light can not only propagate to the first top surface M1 and be reflected, but also propagate to the side wall of the pixel electrode 30 and be reflected, thereby improving the reflection ability of the ink portion 21 to light and increasing the display brightness of the display panel 100.

It should be noted that there may be various positional relationships between the ink portion 21 and the pixel electrode 30. For example, the orthographic projection of the ink portion 21 on the first substrate 10 may be located outside the orthographic projection of the corresponding pixel electrode 30 on the first substrate 10, and the ink portion 21 and the pixel electrode 30 may be spaced apart or adjacent to each other. Alternatively, the portion of the ink portion 21 that extends beyond the pixel electrode 30 in the thickness direction Z of the first substrate 10 may cover the portion of the surface of the pixel electrode 30 on the side away from the first substrate 10. The embodiments of the present application do not limit this.

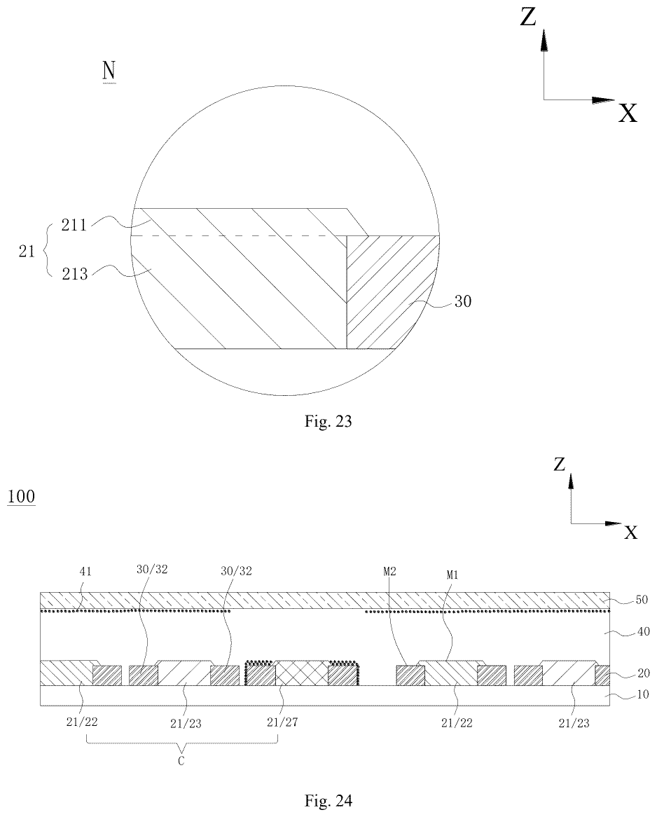

In some embodiments, with reference to FIG. 22 and FIG. 23, the ink portion 21 includes a second protrusion 211 located on the side of the pixel electrode 30 away from the first substrate 10, and the orthographic projection of the second protrusion 211 on the first substrate 10 overlaps with an edge of the orthographic projection of the pixel electrode 30 on the first substrate 10.

The second protrusion 211 is a partial structure of the ink portion 21 that extends beyond the surface of the pixel electrode 30 on the side away from the first substrate 10. With reference to FIG. 22, the ink portion 21 further includes a second body portion 213 in addition to the second protrusion 211. The second body portion 213 is a partial structure of the ink portion 21 that does not extend beyond the surface of the pixel electrode 30 on the side away from the first substrate 10, and the second body portion 213 is connected with the second protrusion 211 into a whole.

In the embodiments of the present application, the top surface of the second protrusion 211 away from the first substrate 10, and the side surface of the second protrusion 211, are both exposed within the electrophoresis layer 40. Both the top surface and side surface of the second protrusion 211 can be used for reflecting ambient light to meet the display requirements of the display panel 100 at the ink portion 21. On this basis, by increasing the size of the second protrusion 211 to make its orthographic projection on the first substrate 10 overlap with the edge of the orthographic projection of the pixel electrode 30 on the first substrate 10, the size of at least one of the top surface and side surface of the second protrusion 211 can be increased, thereby enhancing the reflection effect of the ink portion 21 on ambient light and improving the display brightness of the display panel 100.

In addition, the second ink portion 23 covers only the edge region of the pixel electrode 30, and the central region of the surface of the pixel electrode 30 on the side away from the first substrate 10 is still exposed in the electrophoresis layer 40 and plays a role in adsorbing the electrophoretic particles 41, thereby meeting the screen switching requirements of the display panel 100.

In some embodiments, with reference to FIG. 24, the overlap area of the orthographic projections of the second protrusion 211 corresponding to the first ink portion 22 and the pixel electrode 30 on the first substrate 10 is greater than that of the orthographic projections of the second protrusion 211 corresponding to the second ink portion 23 and the pixel electrode 30 on the first substrate 10.

From the above content, it can be seen that the size of the second protrusion 211 often determines the reflection effect of the ink portion 21 on ambient light. On this basis, the increase in the overlap area of the corresponding orthographic projections of the second protrusion 211 and the pixel electrode 30 can increase the size of at least one of the top surface or side surface of the second protrusion 211, thereby improving its reflection effect on ambient light.

On this basis, in the embodiments of the present application, the overlap area of the second protrusion 211 corresponding to the first ink portion 22 and the pixel electrode 30 is greater than that of the second protrusion 211 corresponding to the second ink portion 23 and the pixel electrode 30, which is conducive to increasing the reflected light intensity of the display panel 100 at the first ink portion 22, such that the reflected light intensities corresponding to the first ink portion 22 and the second ink portion 23 are different to meet different requirements of the display panel 100.

Optionally, considering that the human eyes are more sensitive to green light, the first ink portion 22 includes the green ink portion 21, and the second ink portion 23 includes either the blue ink portion 21 or the red ink portion 21. On this basis, in the embodiments of the present application, the overlap area of the orthographic projections of the second protrusion 211 corresponding to the first ink portion 22 and the pixel electrode 30 on the first substrate 10 is greater than that of the orthographic projections of the second protrusion 211 corresponding to the second ink portion 23 and the pixel electrode 30 on the first substrate 10, which is conducive to increasing the reflection brightness of green light and improving the use experience of the display panel 100.

Of course, in addition to changing the orthographic projection size of the second protrusion 211 corresponding to different ink portions 21 on the first substrate 10, in other embodiments, the thickness of the first ink portion 22 corresponding to the second protrusion 211 may be greater than that of the first ink portion 22 corresponding to the second protrusion 211, which can also make the reflected light intensities of the first ink portion 22 and the second ink portion 23 different to meet different requirements of the display panel 100.

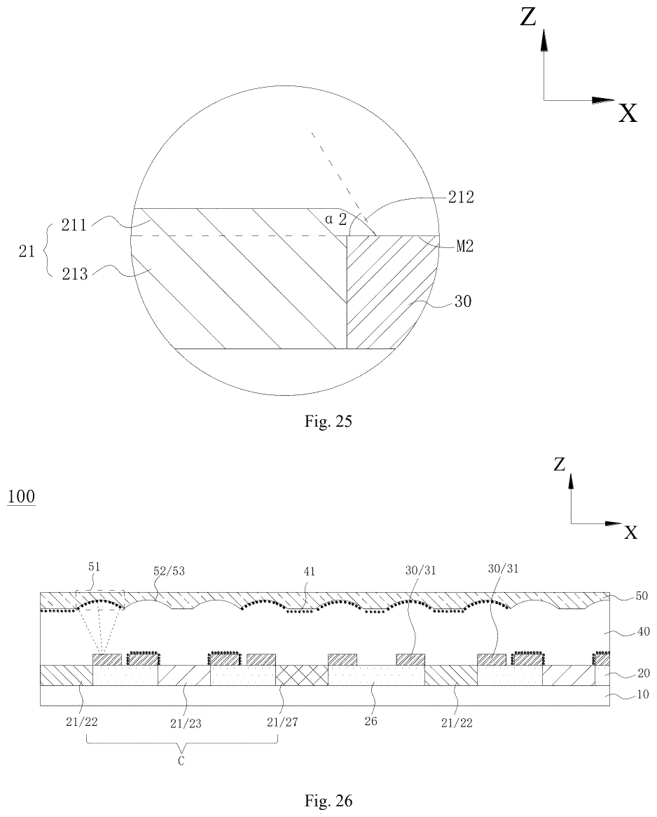

In some embodiments, with reference to FIG. 25, in the direction parallel to the plane where the first substrate 10 is located, the second protrusion 211 has a second side wall, where the second side wall includes a first arc surface 212 protruding outward.

The second side wall is a peripheral wall of the second protrusion 211. The second side wall includes a first arc surface 212, that is, the second side wall has an arc region, and the arc region is convex outward. In the embodiments of the present application, some ambient light can be reflected at the second side wall to increase the reflected light intensity at the ink portion 21. On this basis, the second side wall includes the first arc surface 212 protruding outward, such that the diffusion uniformity of light at the second side wall is better by means of the first arc surface 212, and ambient light can diffuse in more directions after being reflected by the second side wall, thereby reducing the occurrence of dark fringes caused by low reflection brightness in the region between the adjacent ink portions 21 and improving display uniformity.

In some embodiments, as shown in FIG. 25, the angle between a tangent plane 214 of the first arc surface 212 at a position in contact with the pixel electrode 30 and the surface of the pixel electrode 30 on the side away from the first substrate 10 is α2, and α2 satisfies: 5°≤α2≤65°. Optionally, α2 may be one of 5°, 25°, 30°, 45°, 60°, and 65°.

Because the first arc surface 212 protrudes outward, the angle α2 between the second top surface M2 and the tangent plane of the first arc surface 212 at the position in contact with the pixel electrode 30 is greater than the angle between the second top surface M2 and the tangent plane of the first arc surface 212 at other positions, and the angle between the second top surface M2 and the tangent plane 214 of the first arc surface 212 at the position in contact with the top surface of the second protrusion 211 may be 0°. In other words, in the direction perpendicular to the plane where the first substrate 10 is located and away from the first substrate 10, the angle between the corresponding tangent plane of the first arc surface 212 and the second top surface M2 gradually decreases and can ultimately be 0, where α2 is the maximum angle that can be formed between the tangent plane of the first arc surface 212 and the second top surface M2.

Further, in the embodiments of the present application, the angle α2 is not less than 5°, such that the first arc surface 212 can have a relatively large degree of curvature, thereby improving the reflection and diffusion effect of the first arc surface 212 on ambient light and reducing the occurrence of dark fringes on the display panel 100. Meanwhile, the angle α2 is not more than 65°, thereby reducing the occurrence of color mixing and bright fringes caused by the overlap of reflected light from different ink portions 21, and further improving the display uniformity and reliability of the display panel 100.

In some embodiments, the colored ink layer 20 includes a plurality of repeat units C arranged in an array, where the repeat unit C includes at least one first ink portion 22 and at least one second ink portion 23. The curvature of the first arc surface 212 corresponding to the ink portion 21 at an edge position in the repeat unit C is greater than that of the first arc surface 212 corresponding to other ink portions 21 in the repeat unit C.

The expression “ink portion 21 at an edge position in the repeat unit C” mentioned here refers to the ink portion 21 in the single repeat unit C that is closest to another adjacent repeat unit C. For example, in FIG. 5, the repeat unit C includes a first ink portion 22, a second ink portion 23, and a third ink portion 27 arranged sequentially side by side along the first direction X, and the plurality of repeat units C are arranged side by side in the first direction X. On this basis, the first ink portion 22 and the third ink portion 27 are the ink portions 21 at edge positions in the repeat unit C, while the second ink portion 23 is the other ink portion 21 in the repeat unit C.

Considering that the distance between the adjacent repeat units C is often greater than that between the adjacent ink portions 21 in the single repeat unit C, the reflected light corresponding to the ink portions 21 does not fully cover the region between the adjacent repeat units C, such that the display panel 100 is prone to the risk of dark fringes between the adjacent repeat units C.

In view of this, in the embodiments of the present application, the curvature of the first arc surface 212 corresponding to the ink portion 21 at the edge position in the repeat unit C is greater than that of the first arc surface 212 corresponding to other ink portions 21 in the repeat unit C, such that the first arc surface 212 of the ink portion 21 at the edge position has a larger curvature, thereby increasing its ability to reflect and diffuse ambient light, and enabling the reflected light to better cover the region between the adjacent repeat units C to reduce the occurrence of dark fringes. Meanwhile, the first arc surface 212 of the ink portion 21 at other positions has a smaller curvature, thereby reducing the occurrence of color mixing and bright fringes caused by the overlap of reflected light from different ink portions 21, and further improving the display uniformity and reliability of the display panel 100.

In some embodiments, with reference to FIG. 26, the display panel 100 further includes a common electrode 50 located on the side of the electrophoresis layer 40 away from the first substrate 10, the common electrode 50 includes a plurality of electrode portions 51, and the orthographic projections of the different electrode portions 51 on the first substrate 10 cover the orthographic projections of the different pixel electrodes 30 on the first substrate 10. The electrode portion 51 includes a first surface 52 facing the pixel electrode 30, and the distance between the second arc surface 53 and the first substrate 10 gradually decreases in the direction parallel to the plane where the first substrate 10 is located and pointing from the center of the pixel electrode 30 to the edge. In other words, the second arc surface 53 protrudes away from the first substrate 10. In FIG. 25, the single electrode portion 51 is illustrated by a dashed box.

The electrode portion 51 is a partial structure corresponding to one pixel electrode 30 in the common electrode 50. The pixel electrode 30 and the corresponding electrode portion 51 can jointly form an electric field structure for driving the distribution state of the electrophoretic particles 41 in some regions of the electrophoresis layer 40. Different electrode portions 51 are connected into a whole.

The orthographic projection of the electrode portion 51 on the first substrate 10 usually covers and exceeds the orthographic projection of the corresponding pixel electrode 30 on the first substrate 10, that is, the orthographic projection area of the single electrode portion 51 on the first substrate 10 is often greater than that of the single pixel electrode 30 on the first substrate 10. On this basis, a plurality of electric field lines in the electric field structure formed by the single pixel electrode 30 and the corresponding electrode portion 51 are not all parallel to the thickness direction Z of the first substrate 10, and the closer to the edge position of the electrode portion 51, the larger the angle between the corresponding electric field line and the thickness direction Z of the first substrate 10. In FIG. 25, the electric field lines are illustrated by virtual straight lines.

In view of this, in the embodiments of the present application, the first surface 52 of the electrode portion 51 includes the second arc surface 53 protruding away from the first substrate 10, where the extension direction of the radius of the second arc surface 53 at a different position may be the same as or similar to the direction of the electric field line at that position. On this basis, when the electrophoretic particles 41 move from the electrode portion 51 to the pixel electrode 30 or from the pixel electrode 30 to the electrode portion 51, the movement direction of the electrophoretic particles 41 may be the same as or similar to the direction of the electric field line, thereby improving the movement speed of the electrophoretic particles 41, increasing the response rate, and meeting the requirements for quickly switching the screen of the display panel 100.

In some embodiments, at least some ink portions 21 include laminated ink portion 21 materials of different colors.

The ink portion 21 may be formed by color mixing of various ink materials. For example, in order to meet the specific color requirements of reflected light, the ink portion 21 of a specific color may be manufactured by a color-subtraction process. The color-subtraction process obtains certain color light by reflection and absorption of light waves. When light passes through a pigment or colored object, the object absorbs or “subtracts” certain colors of light, and the reflected light has the color of the object that the human eyes perceive. Taking the green ink portion 21 as an example, the green ink portion 21 may include a yellow ink material and a cyan ink material. After ambient light is absorbed by the yellow ink material and the cyan ink material in the green ink portion 21, only green light is left and reflected, thereby achieving required green light display. The red ink portion 21 may include a magenta ink material and a yellow ink material. The blue ink portion 21 may include a magenta ink material and a cyan ink material.

In the embodiments of the present application, a plurality of ink materials are mixed to form various ink portions 21 of different colors, thereby meeting different color requirements of the display panel 100 and achieving required multi-color display of the display panel 100.

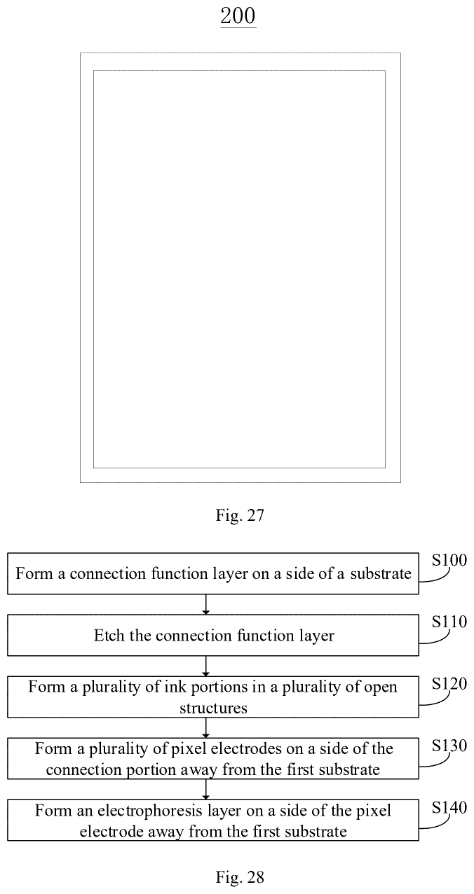

In a second aspect, with reference to FIG. 27, an embodiment of the present application provides a display apparatus 200. The display apparatus 200 includes the display panel according to any of the aforementioned embodiments.

It should be noted that the display apparatus 200 provided in the embodiment of the present application has the beneficial effects of the display panel in any of the aforementioned embodiments, specifically referring to the aforementioned description of the beneficial effects of the display panel 100, which will not be repeated by the embodiments of the present application.

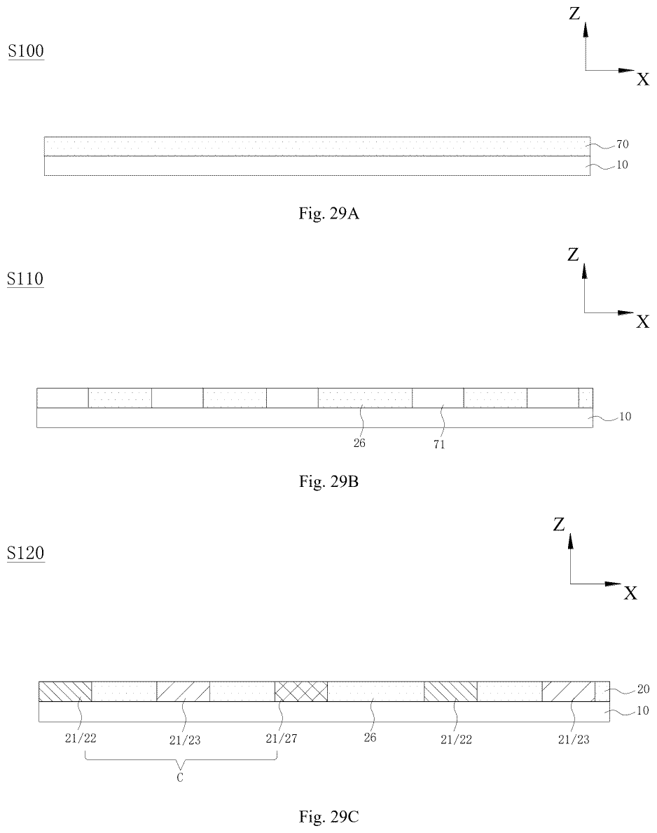

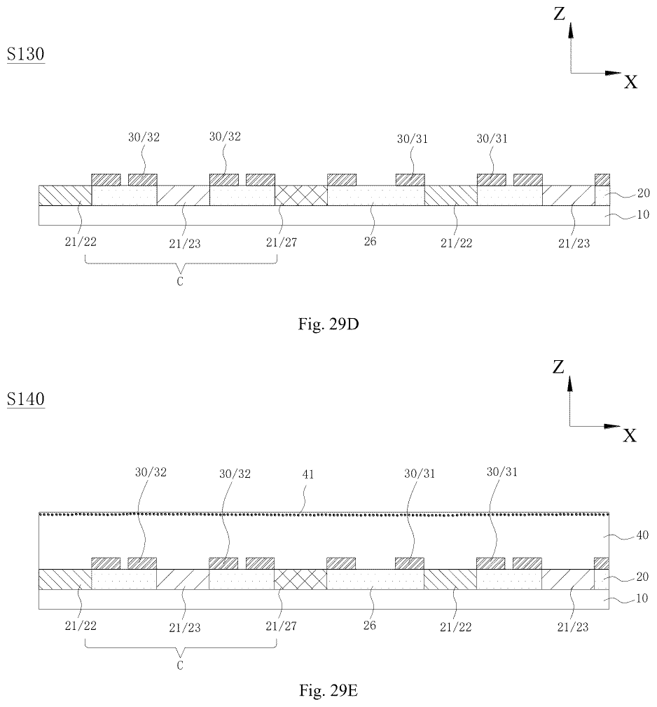

In a third aspect, with reference to FIG. 28 and FIG. 29, an embodiment of the present application provides a manufacturing method for a display panel 100, including the steps described below.

S100: Form a connection function layer on a side of a first substrate.

With reference to FIG. 29A, in step S100, the first substrate 10 plays a supporting and bearing role, the connection function layer 70 is located on one side of the first substrate 10 in a thickness direction Z, and the connection function layer 70 is used for forming a connection portion subsequently.

S110: Etch the connection function layer.

With reference to FIG. 29B, in step S110, a plurality of spaced open structures 71 can be formed by etching, and a one-piece machine is located at the connection portion 26 between the adjacent open structures 71. The open structures 71 are used for accommodating subsequent ink portions 21.

S120: Form a plurality of ink portions in a plurality of open structures.

With reference to FIG. 29C, in step S120, the plurality of ink portions 21 include first ink portions 22 and second ink portions 23 of different colors. The specific colors of the first ink portion 22 and the second ink portion 23 are not limited by the embodiments of the present application. Optionally, the first ink portion 22 includes a green ink portion 21, and the second ink portion 23 includes one of a red ink portion 21 and a blue ink portion 21. In addition, the formation of the ink portions 21 is also not limited by the embodiments of the present application. Optionally, the ink portions 21 may be formed by ink-jet printing or the like.

S130: Form a plurality of pixel electrodes on a side of the connection portion away from the first substrate.

With reference to FIG. 29D, in step S130, the pixel electrodes 30 include first electrodes 31 corresponding to the first ink portion 22 and second electrodes 32 corresponding to the second ink portion 23, the orthographic projection of the first ink portion 22 on the first substrate 10 is at least partially located between the orthographic projections of two of the first electrodes 31 on the first substrate 10, and the orthographic projection of the second ink portion 23 on the first substrate 10 is at least partially located between the orthographic projections of two of the second electrodes 32 on the first substrate 10.

The expression “first electrode 31 corresponding to the first ink portion 22” means that the first electrode 31 can control some electrophoretic particles 41 corresponding to the position of the first ink portion 22. In other words, the electrophoresis layer 40 has a first region overlapping the orthographic projection of the first ink portion 22 on the first substrate 10, and the first electrode 31 can control the distribution state of the electrophoretic particles 41 located in the first region. The same applies to the expression “second electrode 32 corresponding to the second ink portion 23”, and will not be repeated by the embodiments of the present application.

S140: Form an electrophoresis layer on a side of the pixel electrode away from the first substrate.

With reference to FIG. 29E, in step S140, the electrophoresis layer 40 includes electrophoretic particles 41. The electrophoresis layer 40 includes only one type of electrophoretic particles 41, and this type of electrophoretic particles 41 can block ambient light. The first electrode 31 and the second electrode 32 respectively correspond to the first ink portion 22 and the second ink portion 23, and independently control the distribution of the electrophoretic particles 41 at the corresponding positions of the first ink portion 22 and the second ink portion 23. On this basis, the display panel 100 can selectively control through the first electrode 31 whether the electrophoretic particles 41 cover the region where the first ink portion 22 is located, thereby adjusting the amount of ambient light propagating to the first ink portion 22 and achieving display control on the specific color corresponding to the first ink portion 22. And the display panel can selectively control through the second electrode 32 whether the electrophoretic particles 41 cover the region where the second ink portion 23 is located, thereby adjusting the amount of ambient light propagating to the second ink portion 23 and achieving display control on the specific color corresponding to the second ink portion 23. In this case, the display panel 100 can achieve the display needs of color images by joint cooperation of the colored ink layer 20, the electrophoresis layer 40, and the pixel electrodes 30.

In the embodiments of the present application, the connection portion 26 with open structures 71 is first formed, and then different ink portions 21 are formed in different open structures 71, thereby defining the position of the single ink portion 21 by means of the open structure 71, and spacing different ink portions 21 apart from each other by means of the connection portion 26. This design is conducive to reducing the difficulty in manufacturing the display panel 100 and improving the manufacturing yield.

Although the disclosed embodiments of the present application are as described above, the described content is only for the purpose of easy understanding of the present application and is not intended to limit the present invention. Any person skilled in the art of the present application may make any modifications and changes in forms and details of implementation without departing from the spirit and scope disclosed in the present application, but the scope of protection of the present application shall still be subject to the scope defined in the appended claims.

Described above are only the specific embodiments of the present application, and those skilled in the art can clearly understand that, for the convenience and conciseness of the description, the replacement of other connections described above and the like can refer to the corresponding processes in the foregoing method embodiments, and will not be repeated here. It should be understood that the protection scope of the present application is not limited thereto. A person skilled in the art can readily conceive various equivalent modifications or replacements within the technical scope disclosed by the present application, and these modifications or replacements shall fall within the protection scope of the present application.

What is claimed is:

1. A display panel, comprising:
a first substrate;
a colored ink layer disposed on a side of the first substrate and comprising a plurality of ink portions, the plurality of ink portions comprising first ink portions and second ink portions having a different color from that of the first ink portions;
a plurality of pixel electrodes disposed at the side of the first substrate, the pixel electrodes comprising first electrodes corresponding to the first ink portions and second electrodes corresponding to the second ink portions; and
an electrophoresis layer disposed on a side of the colored ink layer and the pixel electrodes away from the first substrate, the electrophoresis layer comprising electrophoretic particles;
wherein an orthographic projection of the first ink portion on the first substrate is at least partially located between orthographic projections of two of the first electrodes on the first substrate, and an orthographic projection of the second ink portion on the first substrate is at least partially located between orthographic projections of two of the second electrodes on the first substrate.

2. The display panel according to claim 1, wherein
the display panel further comprises a common electrode located on a side of the electrophoresis layer away from the first substrate,
the electrophoretic particles are positively charged, and
the display panel is provided with
a first color state, in which a voltage of the common electrode is V1, a voltage of the first electrode is V2, a voltage of the second electrode is V3, and V3>V1>V2, and
a second color state, in which the voltage of the common electrode is V4, the voltage of the first electrode is V5, the voltage of the second electrode is V6, and V5>V4>V6.

3. The display panel according to claim 2, wherein the display panel is further provided with a black state in which the voltage of the common electrode is V7, and V7<0.

4. The display panel according to claim 1, wherein orthographic projections of the first electrodes corresponding to one of the first ink portions on the first substrate surround the orthographic projection of the first ink portion on the first substrate, orthographic projections of the second electrodes corresponding to one of the second ink portions on the first substrate surround the orthographic projection of the second ink portion on the first substrate, and the first electrode is spaced apart from the second electrode.

5. The display panel according to claim 4, wherein the first electrodes corresponding to the first ink portion are connected to each other; and/or the second electrodes corresponding to the second ink portion are connected to each other.

6. The display panel according to claim 1, further comprising a support column disposed in the electrophoresis layer, an orthographic projection of the support column on the first substrate being disposed between orthographic projections of adjacent two of the ink portions on the first substrate,
wherein the support column is not provided between some of the ink portions adjacent to each other.

7. The display panel according to claim 6, wherein
the colored ink layer comprises a plurality of repeat units arranged in an array, the repeat unit comprising at least one of the first ink portions and at least one of the second ink portions; and
the orthographic projection of the support column on the first substrate is located between orthographic projections of adjacent two of the repeat units on the first substrate.

8. The display panel according to claim 6, wherein
the plurality of ink portions comprise first-type ink portions and second-type ink portions, the plurality of pixel electrodes comprise first-type electrodes corresponding to the first-type ink portions and second-type electrodes corresponding to the second-type ink portions, an orthographic projection of the first-type ink portion on the first substrate is at least partially located between orthographic projections of two of the first-type electrodes on the first substrate, and an orthographic projection of the second-type ink portion on the first substrate is at least partially located between orthographic projections of two of the second-type electrodes on the first substrate;
the support column is located on a side of the first-type electrode away from the first substrate, and an orthographic projection of the second-type electrode on the first substrate does not overlap with the orthographic projection of the support column on the first substrate; and
an orthographic projection area of the first-type electrode on the first substrate is greater than an orthographic projection area of the second-type electrode on the first substrate.

9. The display panel according to claim 6, wherein
the plurality of ink portions comprise first-type ink portions and second-type ink portions, the plurality of pixel electrodes comprise first-type electrodes corresponding to the first-type ink portions and second electrodes corresponding to the second-type ink portions, an orthographic projection of the first-type ink portion on the first substrate is at least partially located between orthographic projections of two of the first-type electrodes on the first substrate, and an orthographic projection of the second-type ink portion on the first substrate is at least partially located between orthographic projections of two of the second-type electrodes on the first substrate;
the support column is located on a side of the first-type electrode away from the first substrate, and an orthographic projection of the second-type electrode on the first substrate does not overlap with the orthographic projection of the support column on the first substrate; and
a thickness of the first-type ink portion is greater than a thickness of the second-type ink portion, and/or an orthographic projection area of the first-type ink portion on the first substrate is greater than an orthographic projection area of the second-type ink portion on the first substrate.

10. The display panel according to claim 9, wherein the first-type ink portions comprise green ink portions.

11. The display panel according to claim 1, wherein the first ink portions comprise green ink portions, and the second ink portions comprise red ink portions or blue ink portions.

12. The display panel according to claim 11, wherein a thickness of the first ink portion is greater than a thickness of the second ink portion; and/or
an orthographic projection area of the first ink portion on the first substrate is greater than an orthographic projection area of the second ink portion on the first substrate.

13. The display panel according to claim 11, wherein the plurality of ink portions comprise third ink portions, the second ink portions comprise red ink portions, and the third ink portions comprise blue ink portions; and
a thickness of the third ink portion is less than a thickness of at least one of the first ink portion and the second ink portion; and/or an orthographic projection area of the third ink portion on the first substrate is less than an orthographic projection area of at least one of the first ink portion and the second ink portion on the first substrate.

14. The display panel according to claim 1, wherein the colored ink layer further comprises a connection portion located between adjacent two of the ink portions, and the pixel electrode is located on a side of the connection portion away from the first substrate.

15. The display panel according to claim 14, wherein the ink portion has a first orthographic projection on the first substrate, the pixel electrode has a second orthographic projection on the first substrate, and the second orthographic projection does not overlap with the first orthographic projection.

16. The display panel according to claim 15, wherein the first orthographic projection has a first edge facing the second orthographic projection, the second orthographic projection has a second edge facing the first orthographic projection, a distance between the first edge and the second edge is L, and a diameter of the electrophoretic particle is D, where L≥D.

17. The display panel according to claim 16, wherein the distance between the first edge of the first ink portion and the second edge of the first electrode is L1, and the distance between the first edge of the second ink portion and the second edge of the second electrode is L2, wherein L1>L2.

18. The display panel according to claim 1, further comprising a common electrode located on a side of the electrophoresis layer away from the first substrate, the common electrode comprising a plurality of electrode portions, and orthographic projections of different ones of the electrode portions on the first substrate covering orthographic projections of different ones of the different pixel electrodes on the first substrate,
wherein the electrode portion comprises a first surface facing the pixel electrode, and a distance between the second arc surface and the first substrate gradually decreases in a direction parallel to a plane where the first substrate is located and pointing from a center of the pixel electrode toward an edge.

19. The display panel according to claim 1, wherein at least some of the ink portions comprise a plurality of ink materials stacked and having different colors.

20. A display apparatus, comprising a display panel comprising:
a first substrate;
a color ink layer disposed on a side of the first substrate and comprising a plurality of ink portions, the plurality of ink portions comprising first ink portions and second ink portions having different colors;
a plurality of pixel electrodes disposed at the side of the first substrate, the pixel electrodes comprising first electrodes corresponding to the first ink portions and second electrodes corresponding to the second ink portions; and
an electrophoresis layer disposed on a side of the color ink layer and the pixel electrodes away from the first substrate, the electrophoresis layer comprising electrophoretic particles;
wherein an orthographic projection of the first ink portion on the first substrate is at least partially located between orthographic projections of two of the first electrodes on the first substrate, and an orthographic projection of the second ink portion on the first substrate is at least partially located between orthographic projections of two of the second electrodes on the first substrate.
